(19) United States
(12) Patent Application Publication
(10) Pub. No.: US 2010/0233602 A1
(43) Pub. Date: Sep. 16, 2010

(54) Electrophotographic Photoconductor

(75) Inventors: Kohsuke Yamamoto, Numazu-shi (JP); Takaaki Ikegami, Susono-shi (JP); Eiji Kurimoto, Numazu-shi (JP); Keisuke Shimoyama, Numazu-shi (JP); Hideki Nakamura, Kofu-shi (JP); Toshihiko Koizumi, Kofu-shi (JP); Hajime Suzuki, Kofu-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/722,124

(22) Filed: Mar. 11, 2010

(30) Foreign Application Priority Data
Mar. 11, 2009 (JP) 2009-058427
Mar. 13, 2009 (JP) 2009-060965
Mar. 13, 2009 (JP) 2009-061052

(51) Int. Cl. G03G 15/04

(52) U.S. Cl. 430/58.85

(57) ABSTRACT

An electrophotographic photoconductor including a conductive substrate, and a photosensitive layer formed on the conductive substrate, wherein the photosensitive layer contains at least a charge generation agent, a specific charge transfer agent and a specific antioxidant.

### BACKGROUND OF THE INVENTION

1. Field of the Invention

The present invention relates to an electrophotographic photoconductor used in a copier or a printer utilizing electrophotography, particularly the electrophotographic photoconductor having excellent resistance to ozone and NOx.

2. Description of the Related Art

An electrophotographic photoconductor (hereinafter, also referred to as “photoconductor”) needs functions of, bearing surface charge in a dark place, generating charge by accepting light, and transporting charge by accepting light. The electrophotographic photoconductor is classified into a single-layer photoconductor and a so-called functionally-separated multi-layer photoconductor. The single-layer photoconductor has the above-described functions in a layer, and the functionally-separated multi-layer photoconductor is formed of laminating functionally-separated layers, which consist of a layer for charge generation, and a layer for bearing surface charge in a dark place and transporting charge upon accepting light.

For electrophotographic image formation using these photoconductors, the carlson process used.

By using the carlson process, an image is formed by charging a photoconductor by corona discharge in a dark place, forming a latent electrostatic image of a character, picture or the like on the charged surface of the photoconductor, developing the latent electrostatic image using a toner, and fixing the developed toner image on a support such as paper. The photoconductor, from which the toner image has been transferred, is subjected to charge elimination, residual toner removal, and charge elimination by light, etc. and then reused.

Recently, because of flexibility, thermal stability, and film deposition property, an electrophotographic photoconductor using an organic material has been put to practical use.

In recent days, a functionally-separated multi-layer photoconductor, which includes a photosensitive layer consisting of a charge generation layer containing a charge generation agent and a charge transfer layer containing a charge transfer agent, is mainly used. In particular, many negative charging photoconductors have been proposed, which includes the charge generation layer formed by dispersing an organic pigment as the charge generation agent into a deposited layer or a resin, and the charge transfer layer formed by dispersing an organic low-molecular-mass compound as the charge transfer agent into a resin.

The organic material has many advantages, which are not found in an inorganic material. However, in current situation, the organic material which sufficiently satisfies all properties required for the electrophotographic photoconductor has not been obtained. Namely, the image quality is degraded by decrease in charge potential, increase in residual potential, variation in sensitivity, or the like, due to repeated use.

The causes of the degradation of image quality is not totally clarified, but it has been found that oxidizing gases such as ozone, NOx, etc., which are emitted from a corona discharge/charge device, or existed in the air, give remarkable damages to a photosensitive layer. These oxidizing gases chemically change materials in the photoconductor, or form adsorbed materials on the surface of the photosensitive layer, to thereby bring about various property changes. These oxidizing gases bring about, for example, the decrease in charge potential, increase in residual potential and decrease in resolution caused by decrease in surface resistance. As a result, image quality is significantly degraded and hence the life of the photoconductor is shortened. As a countermeasure for these problems, it has been proposed that an antioxidant and a stabilizer are added to the photosensitive layer so as to prevent the deterioration of the photoconductor.

For example, as disclosed in Japanese Patent Application Laid-Open (JP-A) No. 01-230055, many cases of the addition of a hindered phenol antioxidant and/or a hindered amine antioxidant have been proposed. Moreover, the addition of an amine derivative is disclosed in JP-A Nos. 03-172852, 2002-333731, and 04-56866.

These proposals achieve certain effect. In recent years, with increasing demands for high-speed operation, and downsizing of copiers and printers, the photoconductor is required to have high durability and high responsiveness. To attain high responsiveness, it is necessary to use a charge transfer agent having a large molecular mass or low ionization potential (Ip). These charge transfer agents have a low durability to ozone and NOx, and the addition of conventional antioxidants or the like is not sufficient to obtain high durability and high responsiveness.

### BRIEF SUMMARY OF THE INVENTION

The present invention solves these problems and attain the following object. An object of the present invention is to provide an electrophotographic photoconductor which can be downsized and be used in high peripheral speed process according to downsizing and high-speed operation of the copiers and printers, has high durability to ozone and NOx, and high stability, and causes no degradation of electric property, even though repeatedly used.

The inventors of the present invention have intensively studied to solve the problems, and found that an electrophotographic photoconductor having a photosensitive layer containing a charge generation agent, a specific charge transfer agent and a specific antioxidant solves the conventional technical problems, and the present invention has been completed.

The present invention is based on the founding of the inventors of the present invention, and a means for solving the problems is as follows.

<1> An electrophotographic photoconductor including: a conductive substrate; and a photosensitive layer formed on the conductive substrate, wherein the photosensitive layer contains a charge generation agent, a charge transfer agent expressed by General Formula (I), and an antioxidant expressed by General Formula (II):

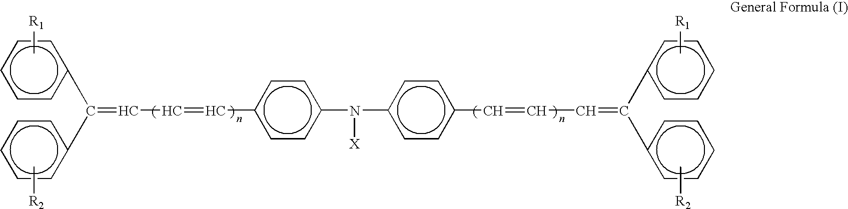

in General Formula (I), X represents any one of General Formulas (III) and (IV); R₁ and R₂ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1;

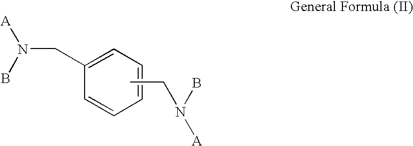

in General Formula (II), A and B each represent any one of substituents expressed by (i) and (ii), and may be identical to each other or different;

—CH₂Y₁, and (i)

—CH₂CH₂Y₂ (i)

in (i) and (ii), Y₁ and Y₂ each represent an aromatic residue which may have a substituent;

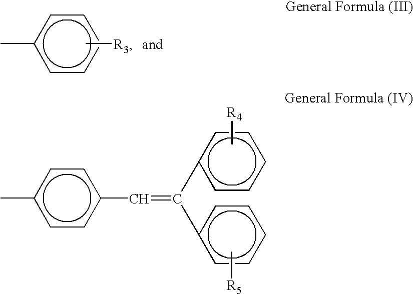

in General Formulas (III) and (IV), R₃ to R₅ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1.

<2> The electrophotographic photoconductor according to <1>, wherein the charge transfer agent expressed by General Formula (I) is a charge transfer agent expressed by General Formula (I-1):

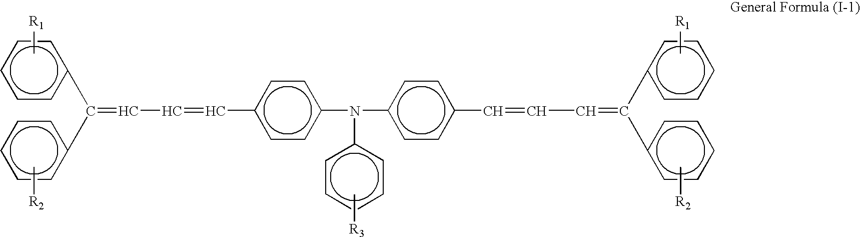

in General Formula (I-1), R₁ to R₃ each represent an alkyl group having 1 to 6 carbon atoms or an alkoxyl group having 1 to 6 carbon atoms, which may have any one of a hydrogen atom, a halogen atom, and a substituent.

<3> The electrophotographic photoconductor according to <1>, wherein the charge transfer agent expressed by General Formula (I) is a charge transfer agent expressed by General Formula (I-2):

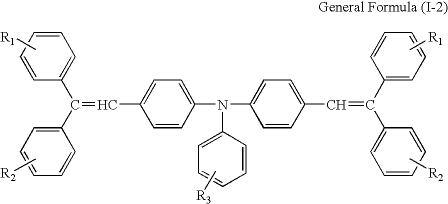

in General Formula (I-2), R₁ to R₃ each represent an alkyl group having 1 to 6 carbon atoms or an alkoxyl group having 1 to 6 carbon atoms, which may have any one of a hydrogen atom, a halogen atom, and a substituent.

<4> The electrophotographic photoconductor according to <1>, wherein the charge transfer agent expressed by General Formula (I) is a charge transfer agent expressed by General Formula (I-3):

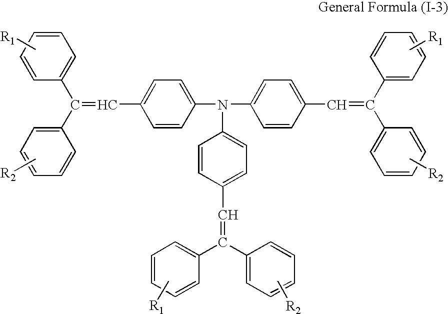

in General Formula (I-3), R₁ and R₂ each represent an alkyl group having 1 to 6 carbon atoms or an alkoxyl group having 1 to 6 carbon atoms, which may have any one of a hydrogen atom, a halogen atom, and a substituent.

<5> The electrophotographic photoconductor according to <2>, wherein the charge transfer agent expressed by General Formula (I-1) is at least one selected from the group consisting of charge transfer agents expressed by Structural Formulas (I-1-a) to (I-1-e):

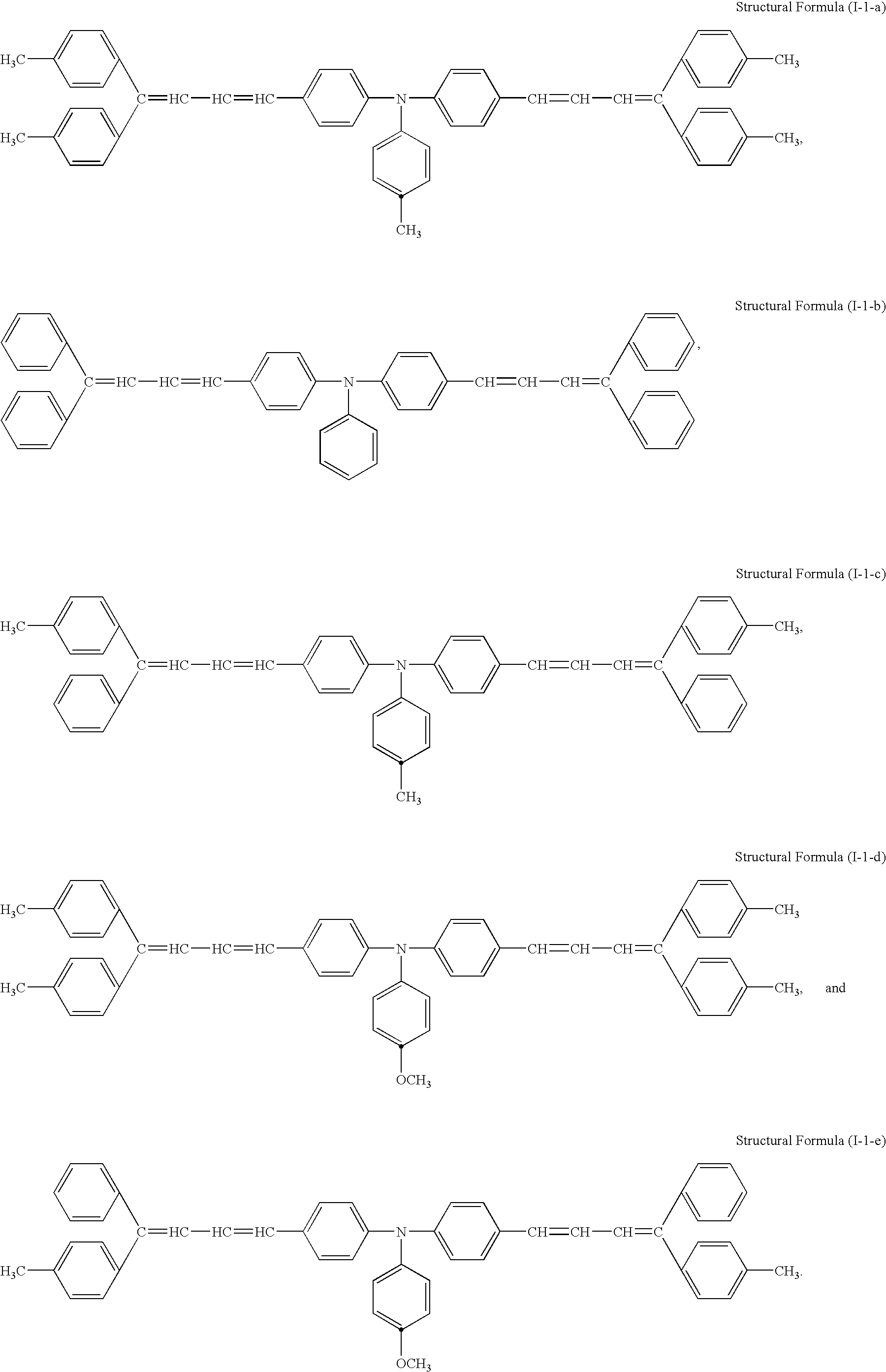

<6> The electrophotographic photoconductor according to <3>, wherein the charge transfer agent expressed by General Formula (I-2) is at least one selected from the group consisting of charge transfer agents expressed by Structural Formulas (I-2-a) to (I-2-e):

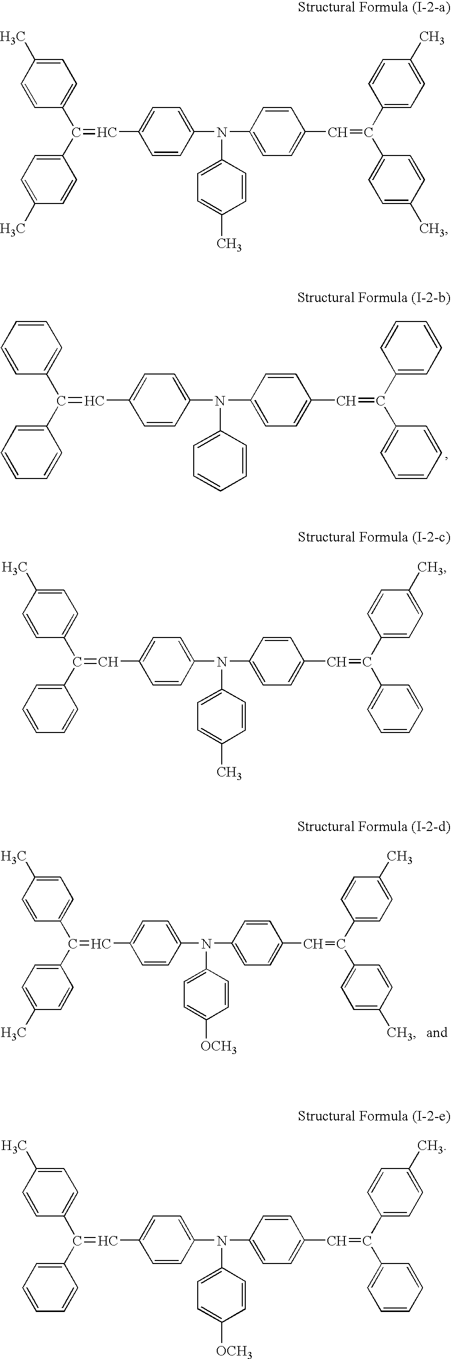

<7> The elecrophotographic photoconductor according to <4>, wherein the charge transfer agent expressed by General Formula (I-3) is at least one selected from the group consisting of charge transfer agents expressed by Structural Formulas (I-3-a) to (I-3-d):

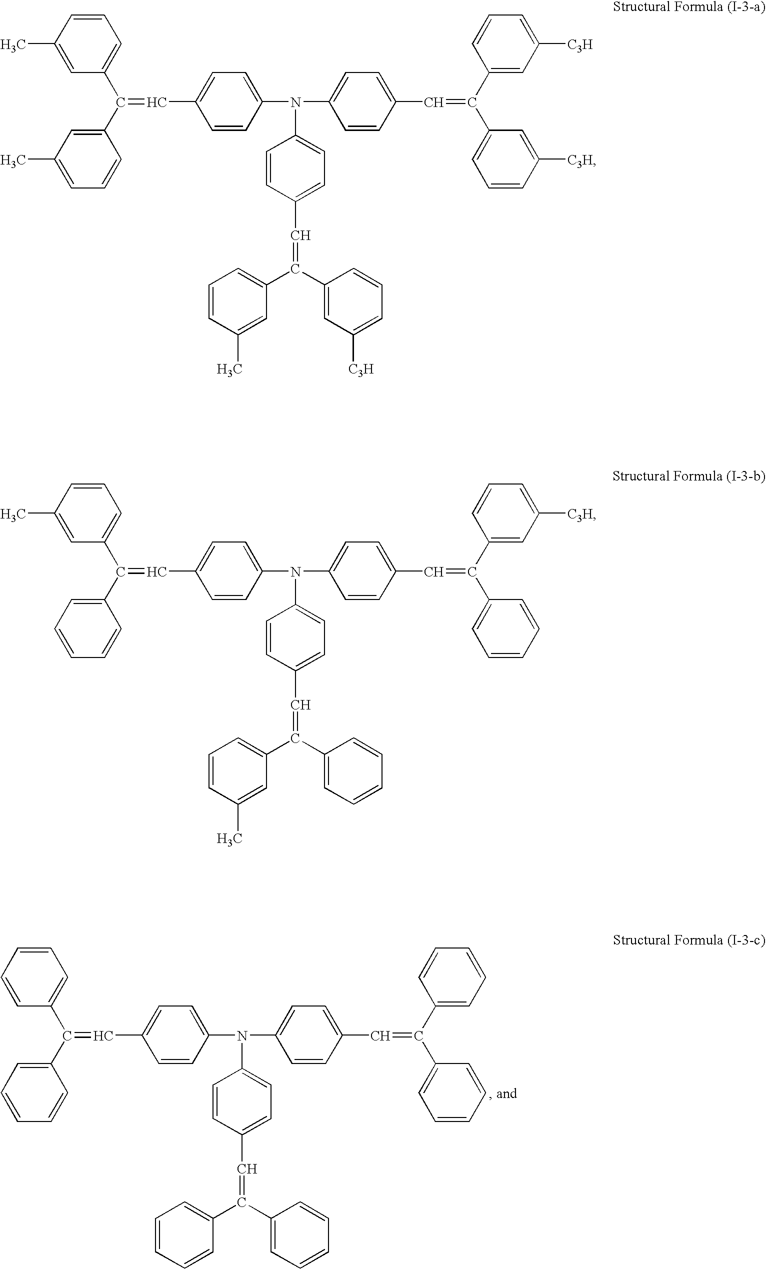

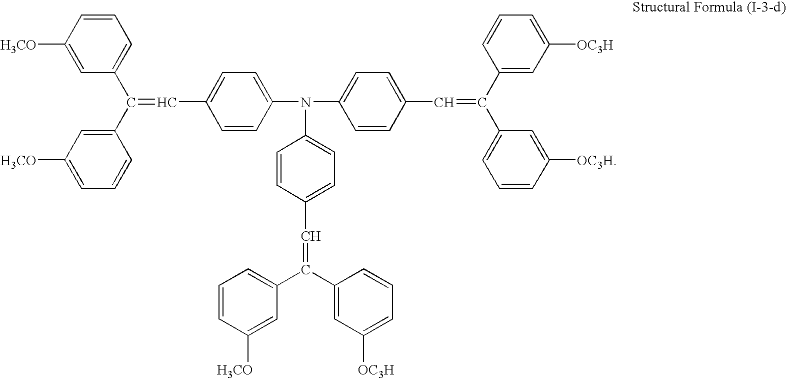

<8> The electrophotographic photoconductor according to any one of <1> to <7>, wherein the antioxidant expressed by General Formula (II) is at least one selected from the group consisting of antioxidants expressed by Structural Formulas (II-a) to (II-e):

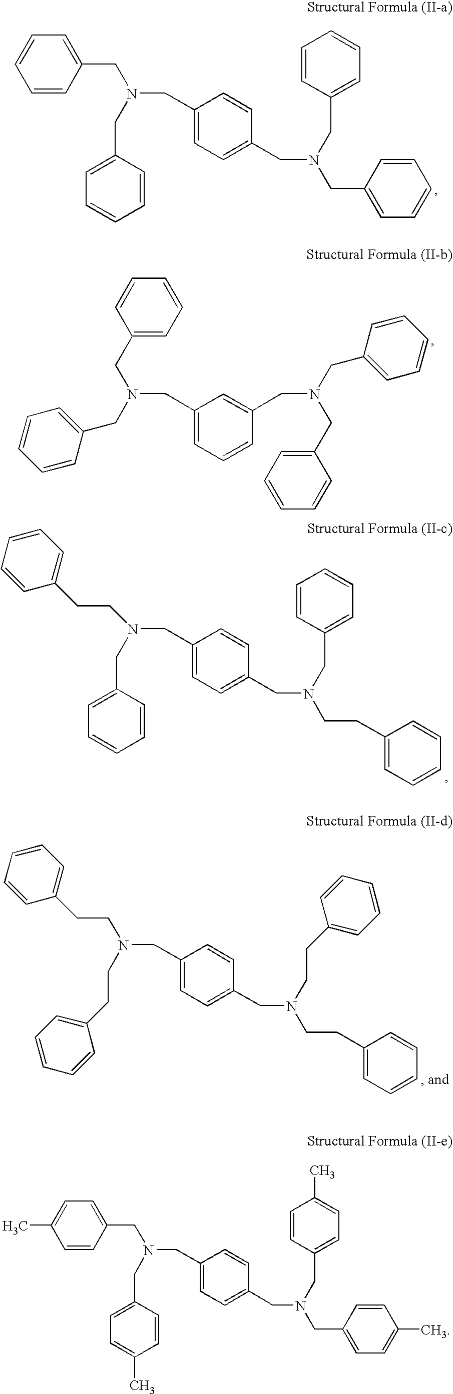

<9> The electrophotographic photoconductor according to any one of <1> to <8>, wherein the photosensitive layer further contains a benzotriazole UV ray absorber.
<10> The electrophotographic photoconductor according to any one of <1> to <9>, wherein the photosensitive layer further contains a phenol antioxidant.

It has been found that the electrophotographic photoconductor of the present invention, which includes the photosensitive layer containing a specific charge transfer agent in combination with a specific antioxidant, has a remarkably low residual potential and an excellent durability to ozone and NOx, and exhibits stable electrophotographic properties even though repeatedly used.

Moreover, as can be seen from the results of the difference in the properties between Examples and Comparative Examples, and the ozone environment test and NOx environment test in Examples and Comparative Examples, which will be described below, the electrophotographic photoconductor of the present invention has high responsiveness and stability for repeated use, and can respond to high demands of the market.

### BRIEF DESCRIPTION OF THE DRAWINGS

FIG. 1 shows a cross-sectional view of an example of a layer configuration of an electrophotographic photoconductor of the present invention.

FIG. 2 shows a cross-sectional view of an example of another layer configuration of an electrophotographic photoconductor of the present invention.

FIG. 3 shows an X-ray diffraction spectrum of oxytitanium phthalocyanine used in Examples.

### DETAILED DESCRIPTION OF THE INVENTION

### Electrophotographic Photoconductor

An electrophotographic photoconductor of the present invention includes a conductive substrate, and a photosensitive layer formed on the conductive substrate, wherein the photosensitive layer contains a charge generation agent, a charge transfer agent, and an antioxidant.

A preferred embodiment of the electrophotographic photoconductor of the present invention will be described with reference to drawings.

The photosensitive layer is generally classified into a single-layer photosensitive layer and a multi-layer photosensitive layer. The single-layer photosensitive layer includes at least a charge generation agent and a charge transfer agent in one layer. The multi-layer photosensitive layer includes a charge generation layer containing a charge generation agent and a charge transfer layer containing a charge transfer agent, wherein these layers are sequentially formed so as to achieve functional separation, and currently the multi-layer photosensitive layer is mainly used.

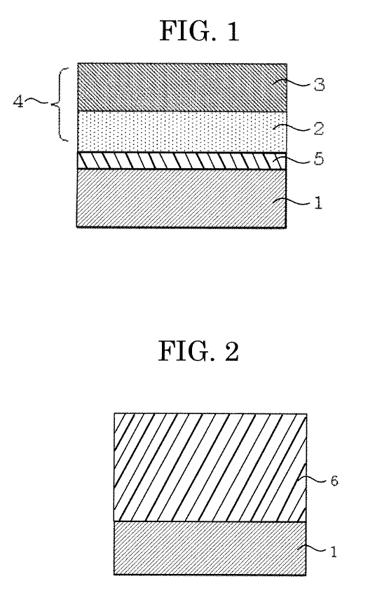

FIG. 1 shows a cross-sectional view of example of a configuration of an electrophotographic photoconductor of the present invention.

The electrophotographic photoconductor is a multi-layer electrophotographic photoconductor, n which a charge generation layer 2 containing at least a charge generation agent is formed over a conductive substrate 1, and a charge transfer layer 3 containing at least a charge transfer agent is formed on the charge generation layer 2. In this case, the charge generation layer 2 and the charge transfer layer 3 form a photosensitive layer 4. 5 denotes an undercoat layer which may be provided for improvement of adhesion, and the like.

### <Charge Transfer Layer>

The charge transfer layer contains at least the charge transfer agent, which will be described below, and an antioxidant. The charge transfer layer can be formed by binding the charge transfer agent and the antioxidant using a binder resin on a charge generation layer serving as a base.

### —Charge Transfer Agent—

The electrophotographic photoconductor of the present invention contains the charge transfer agent expressed by General Formula (I) in the photosensitive layer:

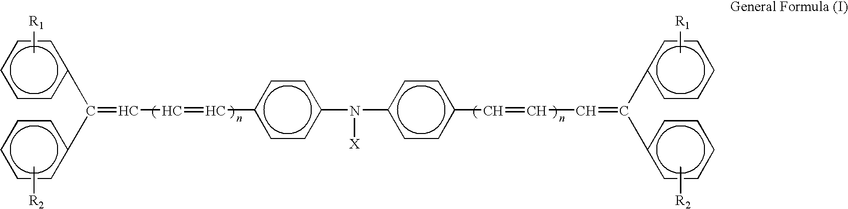

in General Formula (I), X represents any one of General Formulas (III) and (IV); R₁ and R₂ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1;

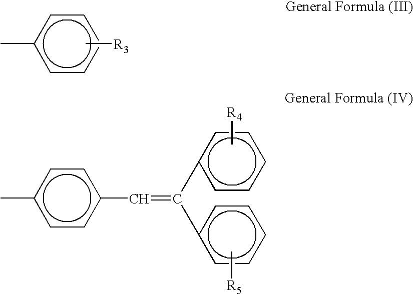

in General Formulas (III) and (IV), R₃ to R₅ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1.

By the use of the charge transfer agent, an electrophotographic photoconductor having high responsiveness and high environment resistance can be provided.

The charge transfer agent expressed by General Formula (I) is not particularly limited and may be appropriately selected depending on the intended use. The charge transfer agent expressed by General Formula (I) is preferably charge transfer agents expressed by General Formula (I-1). General Formula (I-2) and General Formula (I-3), in terms of obtaining an electrophotographic photoconductor having excellent responsiveness. These may be used alone or in combination.

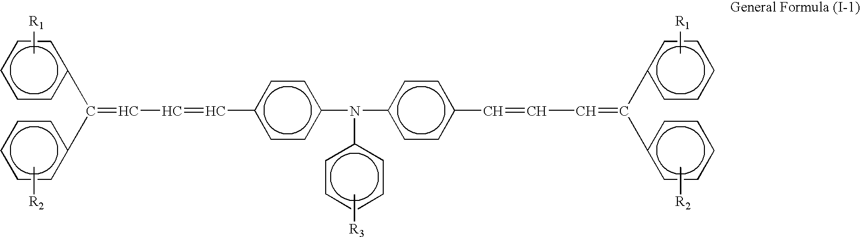

In General Formula (I-1), R₁ to R₃ each represent an alkyl group having 1 to 6 carbon atoms or an alkoxyl group having 1 to 6 carbon atoms, which may have any one of a hydrogen atom, a halogen atom, and a substituent.

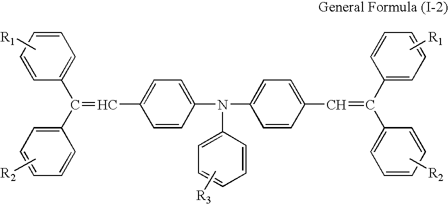

In General Formula (I-2), R₁ to R₃ each represent an alkyl group having 1 to 6 carbon atoms or an alkoxyl group having 1 to 6 carbon atoms, which may have any one of a hydrogen atom, a halogen atom, and a substituent.

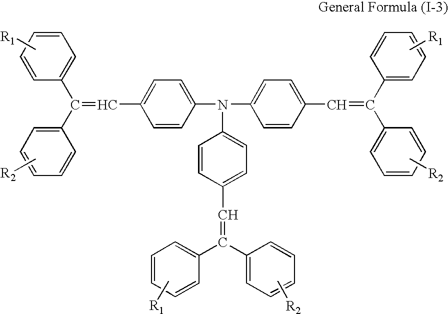

In General Formula (I-3), R₁ and R₂ each represent an alkyl group having 1 to 6 carbon atoms or an alkoxyl group having 1 to 6 carbon atoms, which may have any one of a hydrogen atom, a halogen atom, and a substituent.

The compound expressed by General Formula (I-1) is not particularly limited and may be appropriately selected depending on the intended use. Examples thereof include compounds expressed by Structural Formulas (I-1-a) to (I-1-e).

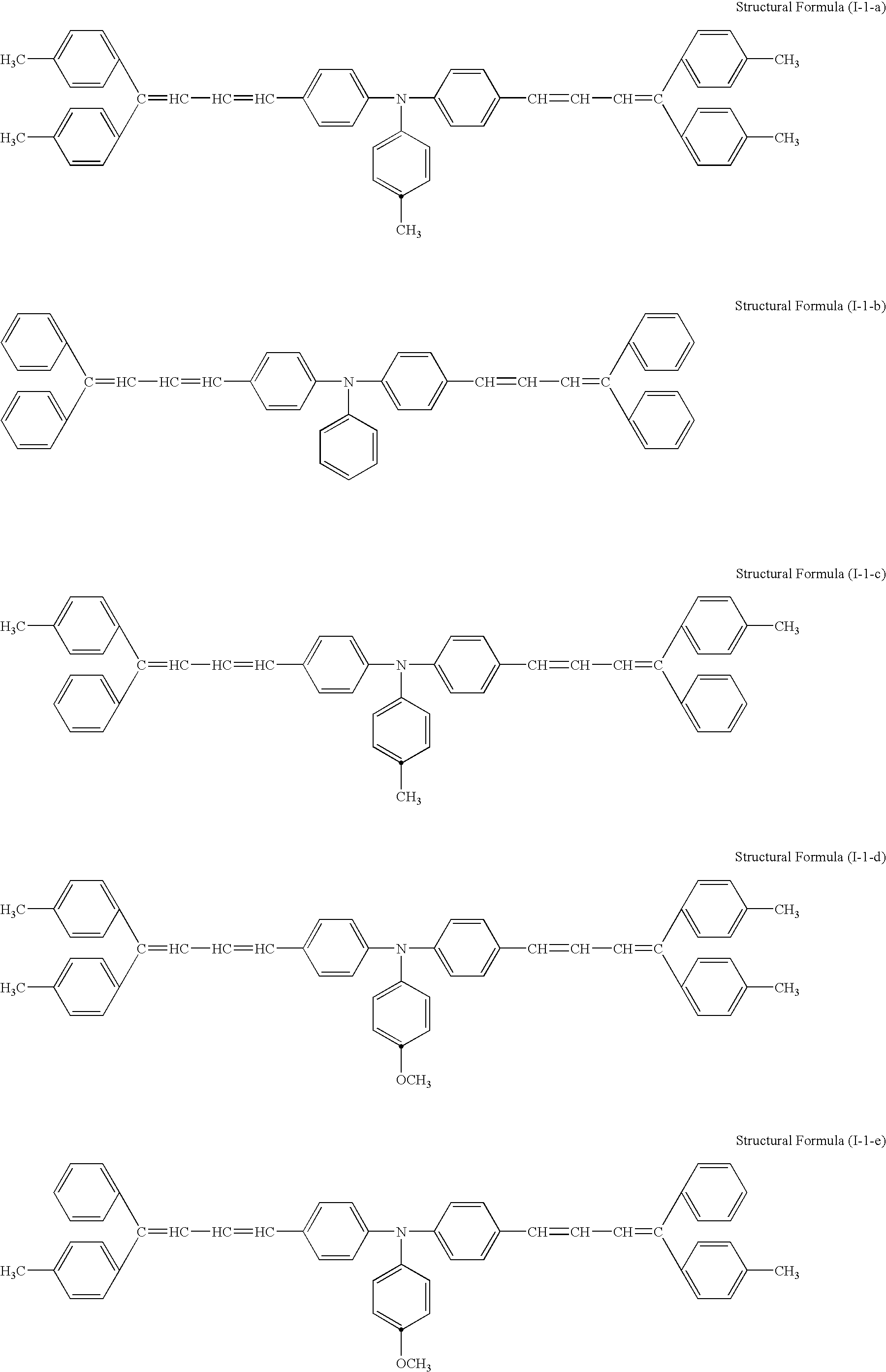

The compound expressed by General Formula (I-2) is not particularly limited and may be appropriately selected depending on the intended use. Examples thereof include compounds expressed by Structural Formulas (I-2-a) to (I-2-e).

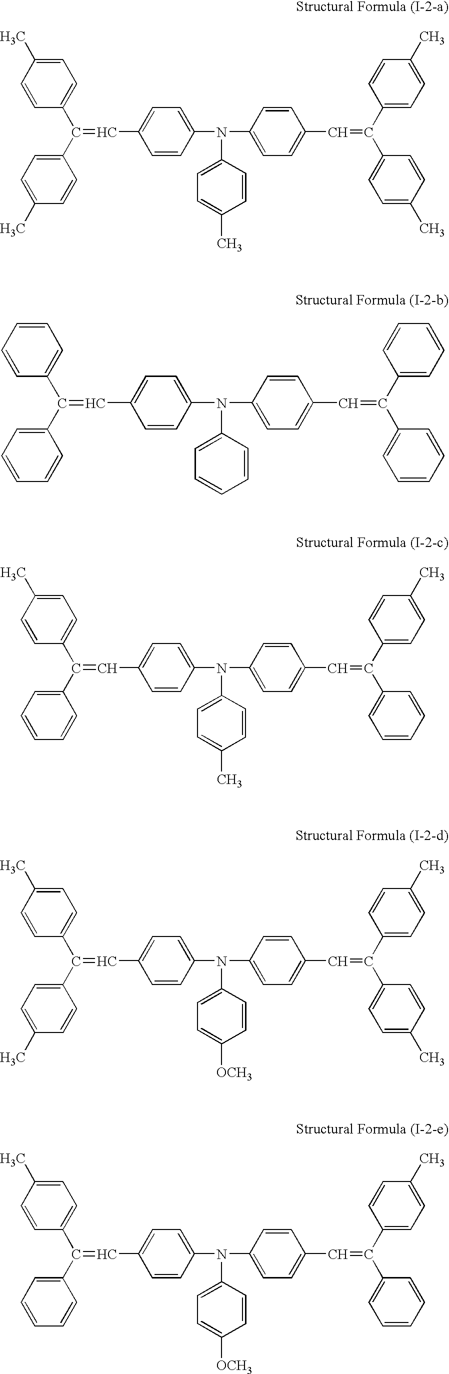

The compound expressed by General Formula (I-3) is not particularly limited and may be appropriately selected depending on the intended use. Examples thereof include compounds expressed by Structural Formulas (I-3-a) to (I-3-d).

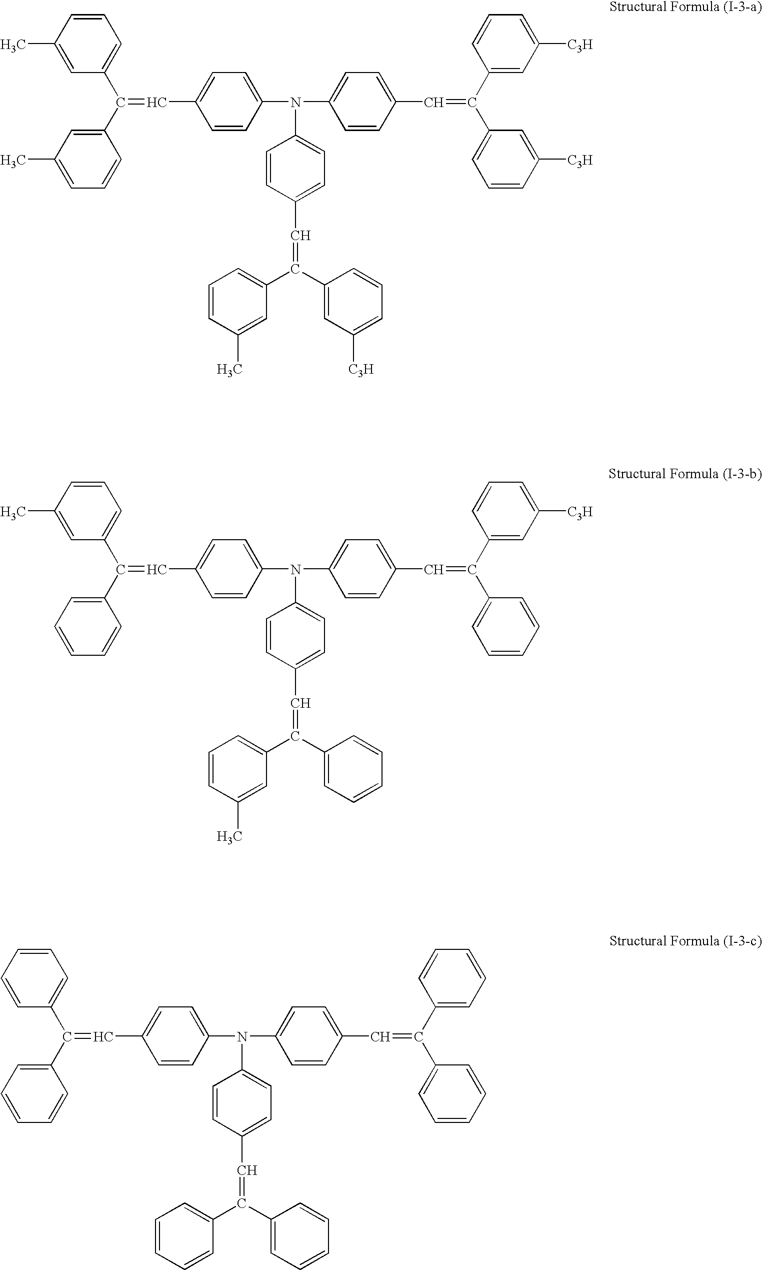

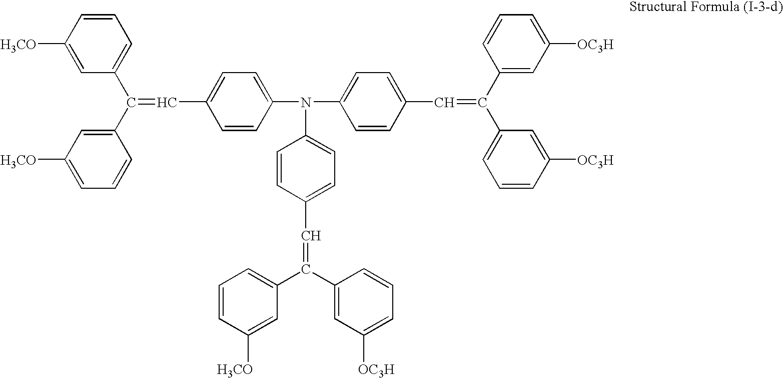

In the case of the multi-layer electrophotographic photoconductor, the amount of the charge transfer agent expressed by General Formula (I) in the charge transfer layer is preferably 0.3 parts by mass to 2.0 parts by mass, relative to 1 part by mass of the binder resin.

When the amount of the compound is less than 0.3 parts by mass, electric property may be degraded, for example, residual potential may be increased. When the amount of the compound is more than 2.0 parts by mass, mechanical property, such as abrasion resistance may be decreased.

Moreover, the specific charge transfer agent expressed by General Formula (I) may be mixed with the other charge transfer agent.

In this case, the content ratio (mass ratio) of the specific charge transfer agent expressed by General Formula (I) and the other charge transfer agent is preferably 50:50 to 95:5, more preferably 70:30 to 95:5.

The other charge transfer agent is not particularly limited and may be appropriately selected depending on the intended use. Examples thereof include high-molecular-mass conductive compounds, such as polyvinylcarbazole, halogenated polyvinylcarbazole, polyvinylpyrene, polyvinylindoloquinoxaline, polyvinylbenzothiophene, polyvinylanthracene, polyvinylacridine, polyvinylpyrazoline, polyacetylene, polythiophene, polypyrrole, polyphenylene, polyphenylenevinylene, polyisothianaphthene, polyaniline, polydiacetylene, polyheptadien, polypyridindiyl, polyquinoline, polyphenylene sulfide, polyferrocenylene, polyperinaphthylene and polyphthalocyanine.

As the other charge transfer agent, a low-molecular-mass compound may also be used. The low-molecular-mass compound is not particularly limited and may be appropriately selected depending on the intended use. Examples thereof include trinitrofluorenone, tetracyanoethylene, tetracyanoquinodimethane, quinone, diphenoquinone, naphthoquinone, anthraquinone, derivatives thereof, polycyclic aromatic compounds (e.g., anthracene, pyrene and phenanthrene), nitrogen-containing heterocyclic compounds (e.g., indole, carbazole and imidazole), fluorenone, fluorene, oxadiazole, oxazole, pyrazoline, hydrazone, triphenylmethane, triphenylamine, enamine and stilbene).

In addition, there can be used a polymer solid electrolyte produced by doping a polymer compound (e.g., polyethylene oxide, polypropylene oxide, polyacrylonitrile or polymethacrylic acid) with a metal ion (e.g., a Li ion), as the charge transfer agent.

Furthermore, as the charge transfer agent, there can be used a charge-transporting organic complex formed of an electron-accepting compound and an electron-donating compound (e.g., tetrathiafulvalene-tetracyanoquinodimethane).

These may be used alone or in combination. Thus, it is possible to impart properties to the photoconductor.

### —Antioxidant—

The electrophotographic photoconductor of the present invention contains the antioxidant expressed by General Formula (II) in the photosensitive layer:

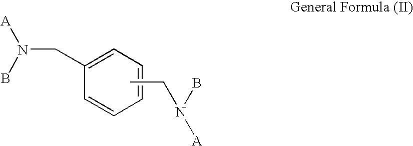

in General Formula (II), A and B each represent any one of substituents expressed by (i) and (ii), and may be identical to each other or different:

—CH₂Y₁, and (i)

—CH₂CH₂Y₂ (ii)

in (i) and (ii), Y₁ and Y₂ each represent an aromatic residue which may have a substituent.

The antioxidant expressed by General Formula (II) is not particularly limited and may be appropriately selected depending on the intended use. The antioxidants expressed by Structural Formulas (II-a) to (II-e) are particularly preferable in terms of providing the electrophotographic photoconductor having a high initial sensitivity, and high resistance to ozone and NOx, and exhibiting stable property.

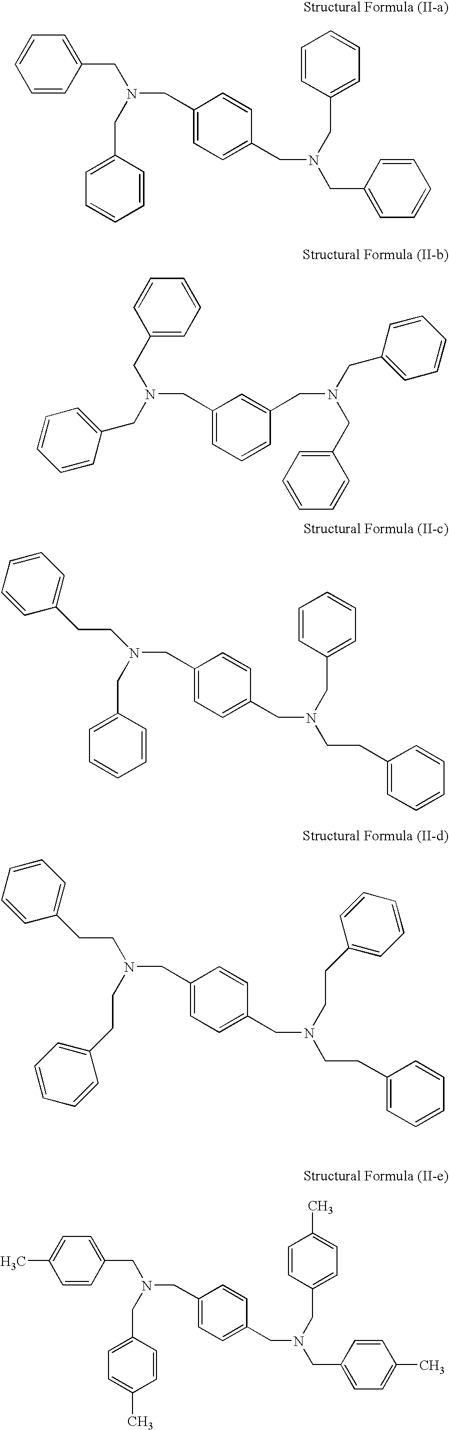

When the electrophotographic photoconductor is a multi-layer electrophotographic photoconductor, the amount of the antioxidant expressed by General Formula (II) contained in the charge transfer layer is not particularly limited and may be appropriately selected depending on the intended use. It is preferably 0.01 parts by mass to 0.30 parts by mass, relative to 1.0 part by mass of the charge transfer agent. When the amount of the antioxidant expressed by General Formula (II) is less so than 0.01 parts by mass, the resistance to ozone and NOx may be decreased, causing adverse effect such as large variation in image density. When the amount is more than 0.30 parts by mass, the electric property may be degraded, such as increase in residual potential.

The thickness of the charge transfer layer is not particularly limited and may be appropriately selected depending on the intended use. It is preferably 3 μm to 50 μm, and more preferably 10 μm to 40 μm, in order to maintain practically effective surface potential.

To the charge transfer layer, various additives such as UV ray absorbers, radical-trapping agents, softeners, hardeners and crosslinking agents, etc, may be added in a range without impairing properties of the photoconductor, so as to improve properties, durability and mechanical properties of the photoconductor.

Particularly, the antioxidant expressed by General Formula (II) is used in combination with at least one of a benzotriazole UV ray absorber and a phenol antioxidant, so as to improve durability of the photoconductor.

The UV ray absorber is not particularly limited and may be appropriately selected depending on the intended use. Examples thereof include benzotriazole UV ray absorbers such as 2-(5-methyl-2-hydroxyphenyl)benzotriazole, 2-(2-hydroxy-3,5-bis(α,α-dimethylbenzyl)phenyl)-2H-benzotriazole, 2-(3,5-di-tert-butyl-2-hydroxyphenyl)benzotriazole, 2-(3-tert-butyl-5-methyl-2-hydroxyphenyl)-5-chlorobenzotriazole, 2-(3,5-di-tert-butyl-2-hydroxyphenyl)-5-chlorobenzotriazole, 2-(3,5-di-tert-amyl-2-hydroxyphenyl)benzotriazole and 2-(2′-hydroxy-5′-tert-octylphenyl)benzotriazole; and salicylic acid UV ray absorbers such as phenyl salicylate, p-tert-butylphenyl salicylate and p-octylphenyl salicylate. These may be used alone or in combination.

The phenol antioxidant is not particularly limited and may be appropriately selected depending on the intended use. Examples thereof include monophenol antioxidants such as 2,6-di-tert-butylphenol, 2,6-di-tert-4-methoxyphenol, 2-tert-butyl-4-methoxyphenol, 2,4-dimethyl-6-tert-butylphenol, 2,6-di-tert-butyl-4-methylphenol, butylated hydroxyanisole, stearyl β-(3,5-di-tert-butyl-4-hydroxyphenyl)propionate, α-tocopherol, β-tocopherol and n-octadecyl-3-(3′-5′-di-tert-butyl-4′-hydroxyphenyl)propionate; and polyphenol antioxidants such as 2,2′-methylenebis(6-tert-butyl-4-methylphenol), 4,4′-butylidene-bis-(3-methyl-6-tert-butylphenol), 4,4′-thiobis-(6-tert-butyl-3-methylphenol), 1,1,3-tris(2-methyl-4-hydroxy-5-tert-butylphenyl)butane, 1,3,5-trimethyl-2,4,6-tris(3,5-di-tert-butyl-4-hydroxybenzyl)benzene and tetrakis(methylene-3-(3,5-di-tert-butyl-4-hydroxyphenyl)propionate) methane. These may be used alone or in combination.

The amount of the UV ray absorber and the antioxidant in the electrophotographic photoconductor of the present invention is not particularly limited and may be appropriately selected depending on the intended use. It is preferably 3 parts by mass to 20 parts by mass relative to 100 parts by mass of the charge transfer agent.

The binder resin used for forming the charge transfer layer is not particularly limited and may be appropriately selected depending on the intended use. Examples thereof include polycarbonate resins, styrene resins, acrylic resins, styrene-acrylic resins, ethylene-vinyl acetate resins, polypropylene resins, vinyl chloride resins, chlorinated polyethers, vinyl chloride-vinyl acetate resins, polyester resins, furan resins, nitrile resins, alkyd resins, polyacetal resins, polymethylpentene resins, polyamide resins, polyurethane resins, epoxy resins, polyarylate resins, diarylate resins, polysulfone resins, polyethersulfone resins, polyallylsulfone resins, silicone resins, ketone resins, polyvinyl butyral resins, polyether resins, phenol resins, ethylene-vinyl acetate (EVA) resins, acrylonitrile-chlorinated polyethylene-styrene (ACS) resins, acrylonitrile-butadiene-styrene (ABS) resins and epoxy arylate resins.

These may be used alone or in combination. It is preferred that the binder resin be mixed with a resin having molecular mass different from that of the binder resin, in terms of improvement in hardness and abrasion resistance.

A solvent used for a coating liquid for applying the charge transfer agent and the binder resin for forming the charge transfer layer is not particularly limited and may be appropriately selected depending on the intended use. Examples thereof include alcohols such as methanol, ethanol, n-propanol, i-propanol and butanol; saturated aliphatic hydrocarbons such as pentane, hexane, heptane, octane, cyclohexane and cycloheptane; aromatic hydrocarbons such as toluene and xylene; chlorine-containing hydrocarbons such as dichloromethane, dichloroethane, chloroform and chlorobenzene; ethers such as dimethyl ether, diethyl ether, tetrahydrofuran (THF), methoxyethanol; ketones such as acetone, methyl ethyl ketone, methyl isobutyl ketone and cyclohexanone; esters such as ethyl formate, propyl formate, methyl acetate, ethyl acetate, propyl acetate, butyl acetate and methyl propionate; ether solvents such as diethyl ether, dimethoxyethane, tetrahydrofuran, dioxolane, dioxane and anisol; N,N-dimethylformamide; and dimethylsulfoxide. These may be used alone or in combination.

Of these, ketone solvents, ester solvents, ether solvents and halogenated hydrocarbon solvents are preferred.

A method for forming the charge transfer layer is not particularly limited and may be appropriately selected from various methods. In a commonly used forming method, the charge transfer agent is dispersed or dissolved in an appropriate solvent together with a binder resin to prepare a coating liquid, and the thus-prepared coating liquid is applied onto the charge generation layer which serves as a base layer thereof, followed by drying.

Moreover, the method can be employed in an inverted multi-layer electrophotographic photoconductor, in which a charge generation layer and a charge transport layer are formed in a reverse order, or in a single-layer electrophotographic photoconductor containing the charge generation agent and the charge transfer agent in one layer.

### <Charge Generation Layer>

### —Charge Generation Agent—

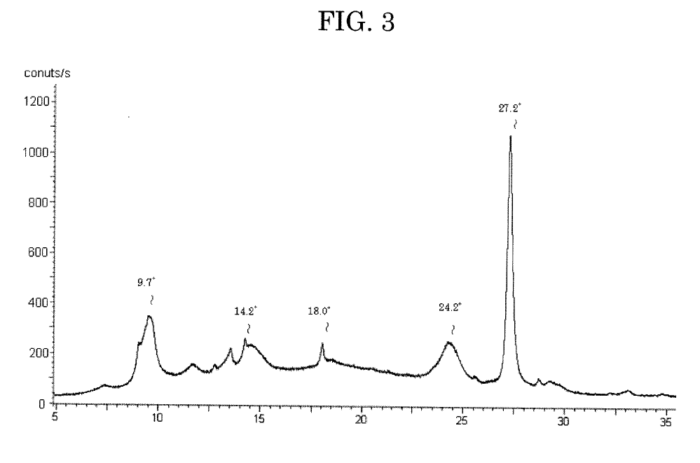

The charge generation agent contained in the charge generation layer used in the present invention is not particularly limited and may be appropriately selected depending on the intended use. Oxytitanium phthalocyanine is preferable because it has a high sensitive property. In particular, oxytitanium phthalocyanine, which has a maximum diffraction peak at least at 27.2° as a diffraction peak at Bragg angle 2θ (±0.2°) with respect to a Cu—Kα characteristic X-ray (1.542 Å (0.1542 nm) wavelength) shown in FIG. 3, is compatible with the charge transfer agent.

Examples of the charge generation agent further include selenium, selenium-tellurium, selenium-arsenic, amorphous silicon, nonmetal phthalocyanine pigments, other metal phthalocyanine pigments, monoazo pigments, disazo pigments, trisazo pigments and polyazo pigments, indigo pigments, threne pigments, toluidine pigments, pyrazoline pigments, perylene pigments, quinacridone pigments, polycyclic quinone pigments, and pyrylium salts.

### —Binder Resin, Solvent—

As a binder resin and solvent used for the coating liquid for forming the charge generation layer, the same as those used for the charge transfer layer can be used. As mentioned in the charge transfer layer, to the charge generation layer, various additives such as UV ray absorbers, radical-trapping agents, softeners, hardeners and crosslinking agents, etc, may be added in a range without impairing properties of the photoconductor, so as to improve properties, durability and mechanical properties of the photoconductor. These are dispersed or dissolved in an appropriate solvent together with the binder resin to prepare a coating liquid, and the thus-prepared coating liquid is applied onto a certain substrate which serves as a base by the various methods as described above, followed by drying.

A method for forming the charge generation layer is not particularly limited and may be appropriately selected depending on the intended use. Examples thereof include dip coating, spray coating, ring coating, bar coating and spinner coating. Specifically, phthalocyanine composition is used as the charge generation agent, and dispersed or dissolved in an appropriate solvent together with the binder resin to prepare a coating liquid, and the thus-prepared coating liquid is applied onto a certain substrate which serves as a base by the various methods as described above, followed by optionally drying.

FIG. 2 shows a cross sectional view of an example of a configuration of a single-layer electrophotographic photoconductor. The single-layer electrophotographic photoconductor includes a conductive substrate 1, and a single-layer photosensitive layer 6 containing at least a charge generation agent and a charge transfer agent formed on the conductive substrate 1. Although it is not shown in FIG. 2, an undercoat layer may also be provided in the single-layer electrophotographic photoconductor as in the case of the multi-layer electrophotographic photoconductor.

The single-layer photosensitive layer contains at least a charge generation agent, the charge transfer agent expressed by General Formula (I), and the antioxidant expressed by General Formula (II).

In the case of the single-layer photosensitive layer, the charge transfer agent expressed by General Formula (I) may be used in combination with the other charge transfer agent (hole transfer agent, electron transfer agent), as in the case of the multi-layer photosensitive layer. In particular, the other electron transfer agent is preferably used in combination with the charge transfer agent expressed by General Formula (I), in order to improve sensitivity.

As the other charge transfer agent (hole transfer agent, electron transfer agent), those mentioned above can be used. These may be used alone or in combination.

In the case where the charge transfer agent expressed by General Formula (I) is mixed with the other hole transfer agent, the content ratio of the charge transfer agent expressed by General Formula (I) to the other hole transfer agent is not particularly limited and may be appropriately selected depending on the intended use. The mass ratio of the charge transfer agent expressed by General Formula (I) and the other hole transfer agent is preferably 50:50 to 95:5, more preferably 70:30 to 95:5.

The amount of the charge transfer agent expressed by General Formula (I) is not particularly limited and may be appropriately selected depending on the intended use. It is preferably 5 parts by mass to 300 parts by mass, more preferably 10 parts by mass to 150 parts by mass, relative to 100 parts by mass of the binder resin.

In the case where the charge transfer agent is used in combination with the other electron transfer agent, the total amount of the charge transfer agent (including the other electron transfer agent) is preferably 20 parts by mass to 300 parts by mass, more preferably 30 parts by mass to 200 parts by mass, relative to 100 parts by mass of the binder resin.

The amount of the antioxidant expressed by General Formula (II) is not particularly limited and may be appropriately selected depending on the intended use. It is preferably 0.01 parts by mass to 0.30 parts by mass, relative to 1.0 part by mass of the charge transfer agent.

As the charge generation agent contained in the single-layer photosensitive layer, the same charge generation agent contained in the charge generation layer of the multi-layer photosensitive layer can be used. The amount of the charge generation agent is not particularly limited and may be appropriately selected depending on the intended use. It is preferably 0.1% by mass to 30% by mass, more preferably 0.5% by mass to 10% by mass, relative to the entire photosensitive layer.

As a binder resin and solvent used for the coating liquid for forming the photosensitive layer, the same as those used for the multi-layer photosensitive layer can be used. As mentioned in the charge transfer layer, to the photosensitive layer, various additives such as UV ray absorbers, radical-trapping agents, softeners, hardeners and crosslinking agents, etc, may be added in a range without impairing properties of the photoconductor, so as to improve properties, durability and mechanical properties of the photoconductor.

These are dispersed or dissolved in an appropriate solvent together with the binder resin to prepare a coating liquid, and the thus-prepared coating liquid is applied onto a certain substrate which serves as a base by the various methods as described above, followed by drying.

The thickness of the single-layer photosensitive layer is not particularly limited and may be appropriately selected depending on the intended use. It is preferably 3 μm to 50 μm, more preferably 10 μm to 40 μm, in terms of maintaining practically effective surface potential.

Optionally, as a surface protective layer on the multi-layer or the single-layer photosensitive layer, an organic thin film may be formed of, for example, a polyvinyl formal resin, a polycarbonate resin, a fluorine resin, a polyurethane resin or a silicone resin; or a thin film having a siloxane structure may be formed by hydrolyzing a silane coupling agent. Provision of the surface protective layer is preferred from the viewpoint of increasing durability of the photoconductor. Also, the surface protective layer may be provided for the purpose of increasing performances other than durability. The thickness of the protective layer is preferably 0.1 μm to 20 μm.

### <Conductive Substrate>

The conductive substrate which can be used in the present invention is not particularly limited and may be appropriately selected depending on the intended use. Examples thereof include processed products of metals and alloys thereof (e.g., aluminum, brass, stainless steel, nickel, chromium, titanium, gold, silver, copper, tin, platinum, molybdenum and indium). The conductive substrate may have any flexible shape such as sheet, film and belt, other than a cylindrical shape, and may be endless. The diameter of the conductive substrate is not particularly limited and may be appropriately selected depending on the intended use. It is preferably 60 mm or less, particularly preferably 30 mm or less.

Of these, aluminum alloys of JIS 3000 series, JIS 5000 series, JIS 6000 series, etc., are preferably used for the conductive substrate. The conductive substrate is molded by any of generally used methods, such as extrusion ironing (EI), extrusion drawing (ED), drawing ironing (DI) and impact ironing (II)). Additionally, the molded conductive substrate may be subjected to surface treatments (e.g., anodizing and polishing) and/or surface lathing with a diamond bite or other tools. Alternatively, it may not be subjected to such treatments; i.e., may be a tube having undergone no surface lathing.

In addition, the conductive substrate may be made of a conductive resin or of resin into which a conductive agent (e.g. metal powder and conductive carbon) has been incorporated.

Furthermore, the conductive substrate may be a glass substrate whose surface has been covered with tin oxide, indium oxide or aluminum iodide for imparting conductivity thereto.

### <Undercoat Layer>

In the electrophotographic photoconductor, an undercoat layer may be formed on the conductive substrate. The undercoat layer has functions of, for example, improving adhesiveness, preventing leak current from an aluminum tube (barrier function), and covering defects formed in/on the surface of an aluminum tube, and for preventing moire. A resin forming the undercoat layer is not particularly limited and may be appropriately selected depending on the intended use. Examples thereof include a polyethylene resin, an acrylic resin, an epoxy resin, a polycarbonate resin, a polyurethane resin, a vinyl chloride resin, a vinyl acetate resin, a polyvinyl butyral resin, a polyamide resin, a nylon resin, an alkyd resin or a melamine resin. These may be used alone or in combination. Also, metal compounds, carbon, silica, resin powder, etc. may be dispersed in the undercoat layer. Furthermore, various pigments, electron-accepting materials, electron-donating materials, etc. may be incorporated thereinto for improving the properties of the electrophotographic photoconductor.

Similar to the photosensitive layer, the undercoat layer may be formed by using an appropriate solvent, method for dispersion or coating. The thickness of the undercoat layer is not particularly limited and may be appropriately selected depending on the intended use. It is preferably 0.1 μm to 50 μm, more preferably 0.5 μm to 20 μm.

In an electrophotographic apparatus in which the electrophotographic photoconductor of the present invention is mounted, a charging unit may employ any of contact charging with a brush or roller and non-contact charging with a scorotron or corotron, and also employ any of positive charging and negative charging. An exposing unit may employ an LED, LD, etc. A developing unit may employ a one-component, two-component, magnetic, or non-magnetic development system. A transfer unit may employ a roller, belt, etc.

### EXAMPLES

Hereinafter, Examples of the electrophotographic photoconductor of the present invention will be described along with experimental so examples, and Comparative Examples.

### <Evaluation of Electrical Property Using Simplified Measuring Device>

The electrophotographic properties of each of electrophotographic photoconductors produced in Examples 1 to 35 and Comparative Examples 1 to 18 was evaluated using a photoconductor drum evaluation device (dynamic mode) under the following conditions.

Each of the electrophotographic photoconductors produced in Examples 1 to 35 and Comparative Examples 1 to 18 was evaluated using an evaluation device for an electrophotographic photoconductor (product of Yamanashi Electronics Co., Ltd.). Specifically, discharge current was adjusted so that each photoconductor was charged at a surface potential of approximately −700V using a scorotron at a temperature of 23° C. and a humidity of 50%. The charge potential under these conditions was regarded as (V0). When the charged photoconductor was irradiated with light having a wavelength of 650 nm using a semiconductor laser, the surface potential of the photoconductor adjusted to be approximately −300V (½) at an exposure energy of 0.13 μJ to 0.15 μJ was regarded as (VH). The surface potential of the photoconductor exposed with light at an exposure energy of 0.6 μJ/cm² was regarded as the residual potential (VL) of the photoconductor.

The electrophotographic photoconductor was exposed to ozone gas at a concentration of 5 ppm for 5 days using an ozone exposure test device (product of Dylec Inc.), and then the surface potential (V0), sensitivity potential (VH) and residual potential (VL) of the photoconductor before and after ozone exposure were measured.

Charge elimination was performed using an LED with a wavelength being 660 nm (20 μW).

The electrophotographic photoconductor drum rotated at 150 rpm and it took 0.06 sec to reach a measurement point from a laser irradiation point (the movement time from an exposure point to a measurement point). The results are shown in Tables 1, 3, and 5.

Similarly, the electrophotographic photoconductor was exposed to NOx gas at a NO concentration of 40 ppm and a NO₂ concentration of 10 ppm for 4 days using a NOx exposure test device (product of Dylec Inc.), and then the surface potential (V0), sensitivity potential (VH) and residual potential (VL) of the photoconductor before and after ozone exposure were measured.

Charge elimination was performed using an LED with a wavelength being 660 nm (20 μW).

The electrophotographic photoconductor drum rotated at 150 rpm and it took 0.06 sec to reach a measurement point from a laser irradiation point (the movement time from an exposure point to a measurement point). The results are shown in Tables 1, 3, and 5.

In Tables 1, 3, and 5, the smaller the amount of potential variation from the initial setting values: V0 of approximately 700 (−V), VH of approximately 350 (−V) after the photoconductor was irradiated with light was, the better the photoconductor were. On the other hand, the smaller the value of VL was, the better responsiveness the photoconductor had.

### <Image Evaluation (Halftone Value) Using Device>

By the use of each of the electrophotographic photoconductors produced in Examples 1 to 35 and Comparative Examples 1 to 18 as described below, the initial photoconductor and the photoconductor which had been subjected to ozone exposure test or NOx exposure test were respectively mounted in a color printer (IPSIO SP C220, a product of Ricoh Company, Ltd.), and halftone images (2 by 2) were output in a normal temperature environment at a temperature of 23° C. and a humidity of 50%. The results of the difference in image density ΔID (measured by Macbeth densitometer) between the image obtained from the printer including the initial photoconductor and the image obtained from the printer including the photoconductor after exposure are shown in Tables 2, 4 and 6.

ΔID=Initial ID−ID after exposure test

### Example 1

An alkyd resin (BECKOLITE M-6401-50, product of DIC Corporation) and an amino resin (SUPER BECKAMINE G-821-60, so product of DIC Corporation) were mixed each other at a mass ratio of 65:35. The resultant resin mixture and titanium oxide (CR-EL, product of ISHIHARA SANGYO KAISHA, LTD.) in a mass ratio of 1:3 were dissolved in methyl ethyl ketone to prepare a coating liquid. The thus-prepared coating liquid was applied onto a cylindrical aluminum drum having undergone no surface lathing (diameter: 24 mm) to have a thickness of 1.5 μm, to thereby form an undercoat layer.

### —Synthesis of Oxytitanium Phthalocyanine—

Into a mixture of 64.4 g of phthalodinitrile and 150 mL of α-chloronaphthalene, 6.5 mL of titanium tetrachloride was dripped under nitrogen airflow for 5 minutes. After dripping, it was then heated to a temperature of 200° C. for 2 hours by a mantle heater. After reaction was completed, a deposit was filtered and a filtered residue was washed with α-chloronaphthalen then washed with chloroform, and further washed with methanol. Thereafter, hydrolysis reaction was performed using a mixed liquid of 60 mL of concentrated ammonia water and 60 mL of ion-exchanged water under boiling point for 10 hours, and the reactant was suction filtered at room temperature, and washed with ion-exchanged water until the wash fluid became neutral, and then washed with methanol, and dried with hot air at 90° C. for 10 hours, to thereby obtain 64.6 g of violet-blue crystal titanyl phthalocyanine powder. Next, the violet-blue crystal titanyl phthalocyanine powder was dissolved in 10 times its volume of a concentrated sulfuric acid, and immersed in water so as to deposit crystals, and the crystals were filtered to obtain a wet cake. The wet cake was stirred in dichloroethane at room temperature for 1 hour, to thereby obtain 40 g of oxytitanium phthalocyanine used in Examples.

The spectrum of the oxytitanium phthalocyanine is shown in FIG. 3. As can be seen from FIG. 3, the oxytitanium phthalocyanine had at least a maximum diffraction peak at 27.2° as a diffraction peak at a Bragg angle 2θ (±0.2° with respect to a Cu—Kα characteristic X-ray (1.542 Å (0.1542 nm) wavelength).

A polyvinyl butyral resin (BM-1, product of SEKISUI CHEMICAL CO., LTD.) (10 g) was dissolved in 1,3-dioxolane (500 mL). Thereafter, the oxytitanium phthalocyanine powder (10 and glass beads were added to the above-prepared solution, followed by dispersing for 20 hours with a sand mill disperser. The thus-obtained dispersion liquid was filtered for removing glass beads to prepare a coating liquid for a charge generation layer. The coating liquid was applied onto the above-formed undercoat layer through dip coating, followed by drying, to thereby form a charge generation layer with a thickness of 0.2 μm.

Subsequently, a polycarbonate resin (binder resin, Z400 (product of MITSUBISHI GAS CHEMICAL COMPANY, INC.)), the compound expressed by Structural Formula (1-I-a) (a charge transport agent), the antioxidant expressed by Structural Formula (II-a), and the UV ray absorber expressed by Structural Formula (A) in a mass ratio of 1.0:1.0:0.1:0.1 were dissolved in tetrahydrofuran to prepare a coating liquid for a charge transport layer.

The thus-prepared coating liquid was applied to the substrate on which the charge generation layer had been formed through dip coating, followed by drying at 130° C. for 60 min, to thereby form a charge transport layer with a thickness of 25.0 μm. Thus, an electrophotographic photoconductor was produced.

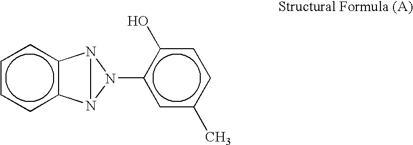

### Example 2

An electrophotographic photoconductor was produced in the same manner as in Example 1, except that the charge transfer agent used in Example 1 was replaced with the charge transfer agent expressed by Structural Formula (1-I-b).

### Example 3

An electrophotographic photoconductor was produced in the same manner as in Example 1, except that the charge transfer agent used in Example 1 was replaced with the charge transfer agent expressed by Structural Formula (1-I-c).

### Example 4

An electrophotographic photoconductor was produced in the same manner as in Example 1, except that the charge transfer agent used in Example 1 was replaced with the charge transfer agent expressed by Structural Formula (I-1-d).

### Example 5

An electrophotographic photoconductor was produced in the same manner as in Example 1, except that the charge transfer agent used in Example 1 was replaced with the charge transfer agent expressed by Structural Formula (1-I-e).

### Example 6

An electrophotographic photoconductor was produced in the same manner as in Example 1, except that the mass ratio of the binder resin, the charge transfer agent expressed by Structural Formula (1-I-a), the antioxidant expressed by Structural Formula (II-a), and the UV ray absorber expressed by Structural Formula (A) for the coating liquid for the charge transfer layer in Example 1 was changed to 1.0:1.0:0.01:0.1.

### Example 7

An electrophotographic photoconductor was produced in the same manner as in Example 1, except that the mass ratio of the binder resin, the charge transfer agent expressed by the Structural Formula (1-I-a), the antioxidant expressed by Structural Formula (II-a), and the UV ray absorber expressed by Structural Formula (A) for the coating liquid for the charge transfer layer in Example 1 was changed to 1.0:1.0:0.3:0.1.

### Example 8

An electrophotographic photoconductor was produced in the same manner as in Example 1, except that the antioxidant expressed by Structural Formula (II-a) used in Example 1 was replaced with the antioxidant expressed by Structural Formula (II-b).

### Example 9

An electrophotographic photoconductor was produced in the same manner as in Example 1, except that the antioxidant expressed by Structural Formula (II-a) used in Example 1 was replaced with the antioxidant expressed by Structural Formula (II-c).

### Example 10

An electrophotographic photoconductor was produced in the same manner as n Example 1, except that the antioxidant expressed by Structural Formula (II-a) used in Example 1 was replaced with the antioxidant expressed by Structural Formula (II-d).

### Example 11

An electrophotographic photoconductor was produced in the same manner as in Example 1, except that the antioxidant expressed by to Structural Formula (II-a) used in Example 1 was replaced with the antioxidant expressed by Structural Formula (II-e).

### Example 12

An electrophotographic photoconductor was produced in the same manner as in Example 1, except that the antioxidant expressed by Structural Formula (B) was added to the coating liquid for the charge transfer layer in Example 1, and that the binder resin, the charge transfer agent expressed by the Structural Formula (1-I-a), the antioxidant expressed by Structural Formula (II-a), the UV ray absorber expressed by Structural Formula (A), and the antioxidant expressed by Structural Formula (B) were in a mass ratio of 1.0:1.0:0.1:0.1:0.1.

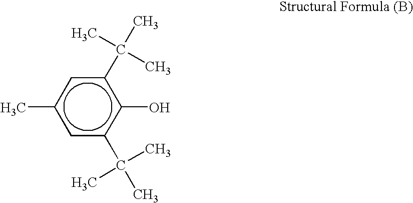

### Comparative Example 1

An electrophotographic photoconductor was produced in the same manner as in Example 1, except that the charge transfer agent expressed by Structural Formula (I-1-a) used in Example 1 was replaced with the charge transfer agent expressed by Structural Formula (C).

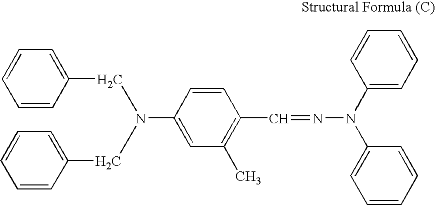

### Comparative Example 2

An electrophotographic photoconductor was produced in the same manner as in Example 1, except that the charge transfer agent expressed by Structural Formula (I-1-a) used in Example 1 was replaced with the charge transfer agent expressed by Structural Formula (D).

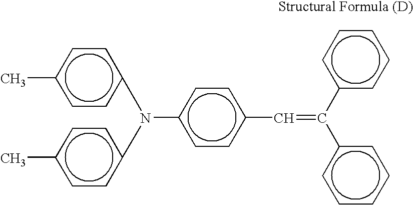

### Comparative Example 3

An electrophotographic photoconductor was produced in the same manner as in Example 1, except that the antioxidant expressed by Structural Formula (II-a) was not contained in the charge transfer layer of Example 1.

### Comparative Example 4

An electrophotographic photoconductor was produced in the same manner as in Example 1, except that the antioxidant expressed by to Structural Formula (II-a) used in Example 1 was replaced with the antioxidant expressed by Structural Formula (B).

### Comparative Example 5

An electrophotographic photoconductor was produced in the same manner as in Example 1, except that the antioxidant expressed by Structural Formula (II-a) used in Example 1 was replaced with the amine antioxidant expressed by Structural Formula (E).

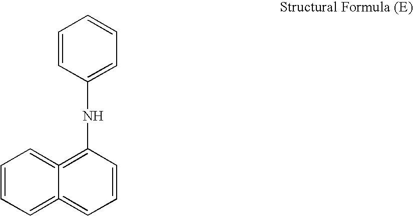

### Comparative Example 6

An electrophotographic photoconductor was produced in the same manner as in Example 1, except that the antioxidant expressed by Structural Formula (II-a) used in Example 1 was replaced with the amine antioxidant expressed by Structural Formula (F).

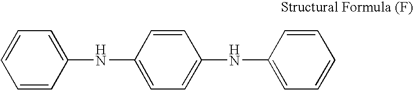

### Comparative Example 7

An electrophotographic photoconductor was produced in the same manner as in Example 1, except that the antioxidant expressed by Structural Formula (II-a) used in Example 1 was replaced with the amine antioxidant expressed by Structural Formula (G).

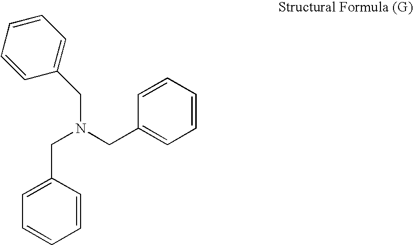

TABLE 1

| | surface potential V0(−V) | | | sensitivity potential VH(−V) | | | residual potential VL(−V) | | |
|---|---|---|---|---|---|---|---|---|---|
| | | ozone | NOx | | ozone | NOx | | ozone | NOx |
| | initial | environment | environment | initial | environment | environment | initial | environment | environment |
| Example 1 | 700 | 690 | 688 | 350 | 342 | 343 | 47 | 47 | 48 |
| Example 2 | 700 | 688 | 687 | 345 | 340 | 338 | 46 | 46 | 47 |
| Example 3 | 700 | 690 | 688 | 342 | 338 | 337 | 47 | 47 | 47 |
| Example 4 | 700 | 687 | 686 | 350 | 342 | 343 | 46 | 46 | 46 |
| Example 5 | 700 | 690 | 688 | 342 | 337 | 337 | 45 | 45 | 46 |
| Example 6 | 700 | 670 | 675 | 345 | 335 | 333 | 46 | 46 | 47 |
| Example 7 | 700 | 692 | 693 | 345 | 342 | 341 | 53 | 53 | 52 |
| Example 8 | 700 | 685 | 683 | 345 | 341 | 340 | 51 | 52 | 51 |
| Example 9 | 700 | 682 | 685 | 347 | 340 | 338 | 53 | 53 | 53 |
| Example 10 | 700 | 687 | 690 | 350 | 342 | 344 | 54 | 54 | 54 |
| Example 11 | 700 | 690 | 687 | 347 | 340 | 342 | 52 | 51 | 51 |
| Example 12 | 700 | 693 | 692 | 350 | 346 | 345 | 51 | 52 | 52 |
| Comparative Example 1 | 710 | 695 | 690 | 400 | 405 | 400 | 160 | 170 | 170 |
| Comparative Example 2 | 710 | 700 | 702 | 380 | 370 | 367 | 110 | 112 | 111 |
| Comparative Example 3 | 700 | 540 | 530 | 340 | 220 | 210 | 46 | 43 | 43 |
| Comparative Example 4 | 700 | 660 | 665 | 340 | 310 | 312 | 47 | 46 | 46 |
| Comparative Example 5 | 700 | 660 | 665 | 345 | 305 | 300 | 55 | 56 | 58 |
| Comparative Example 6 | 700 | 655 | 650 | 345 | 305 | 303 | 59 | 60 | 61 |
| Comparative Example 7 | 700 | 660 | 655 | 350 | 312 | 310 | 48 | 49 | 49 |

TABLE 2

| | ΔID in the case of | ΔID after ozone | ΔID after NOx |
|---|---|---|---|
| | no environmental | environmental | environmental |
| | test performed | test performed | test performed |
| Example 1 | 0 | 0.01 | 0.01 |
| Example 2 | 0 | 0.01 | 0.01 |
| Example 3 | 0 | 0.01 | 0.01 |
| Example 4 | 0 | 0.01 | 0.01 |
| Example 5 | 0 | 0.01 | 0.01 |
| Example 6 | 0 | 0.02 | 0.02 |
| Example 7 | 0 | 0.01 | 0.01 |
| Example 8 | 0 | 0.01 | 0.01 |
| Example 9 | 0 | 0.01 | 0.01 |
| Example 10 | 0 | 0.01 | 0.01 |
| Example 11 | 0 | 0.01 | 0.01 |
| Example 12 | 0 | 0.01 | 0.01 |
| Comparative | 0 | Insufficient | Insufficient |
| Example 1 | | image density | image density |
| | | ΔID could not | ΔID could not |
| | | be evaluated | be evaluated |
| Comparative | 0 | Insufficient | Insufficient |
| Example 2 | | image density | image density |
| | | ΔID could not | ΔID could not |
| | | be evaluated | be evaluated |
| Comparative | 0 | 0.11 | 0.12 |
| Example 3 | | | |
| Comparative | 0 | 0.06 | 0.06 |
| Example 4 | | | |
| Comparative | 0 | 0.07 | 0.06 |
| Example 5 | | | |
| Comparative | 0 | 0.05 | 0.07 |
| Example 6 | | | |
| Comparative | 0 | 0.06 | 0.06 |
| Example 7 | | | |

In each of Examples 1 to 12, the charge transfer agent expressed by General Formula (I) and the antioxidant expressed by General Formula (II) were added to the photosensitive layer, so that the electrophotographic photoconductor had high sensitivity, high responsiveness, and excellent resistance to ozone and NOx. The electrophotographic photoconductor had good results with respect to the variations in charge potential, sensitivity potential, residual potential, and image density.

The electrophotographic photoconductor of Example 6, in which the small amount of the antioxidant expressed by Structural Formula (II-a) was added, was slightly inferior in the surface potential and sensitivity potential to that of Example 1, but the difference in the image density of the resulted images on paper was practical level.

The electrophotographic photoconductor of Example 7, in which the large amount of the antioxidant expressed by Structural Formula (II-a) was added, had somewhat high VL, but the image density was the same level as that of Example 1.

The electrophotographic photoconductors of Comparative Example 1 and Comparative Example 2 were respectively produced by using different charge transfer agents from the one used in Example 1. Both of them had high VH and V0 values, and were hard to respond to a demand for the photoconductor having a high sensitivity and a high responsiveness.

The electrophotographic photoconductor of Comparative Example 3 was produced without adding the antioxidant expressed by Structural Formula (II-a). The values of V0 and VH after ozone exposure and NOx exposure were significantly decreased, and the value of image density change ΔID was significantly increased. From the results of Comparative Example 3 and Example 1, it was understood that a specific bis(N,N-dialkyl substituted)phenylenediamine used for a specific charge transfer agent effected not only antioxidant property, but also ability of improving electrostatic property such as increase in initial sensitivity.

The electrophotographic photoconductors of Comparative Examples 4 to 7 were respectively produced by adding different antioxidants from the one used in Example 1 to the photosensitive layers. The values of V0 and VH after ozone exposure and NOx exposure were less decreased, but the value of VL was increased in some of the electrophotographic photoconductors.

The image density change of each of Comparative Examples 4 to 7 was smaller than that of Comparative Example 3, but was not at the practical level, and inferior to those of Examples 1 to 12.

### Example 13

An electrophotographic photoconductor was produced in the same manner as in Example 1, except that the charge transfer agent used in Example 1 was replaced with the charge transfer agent expressed by Structural Formula (I-2-a).

### Example 14

An electrophotographic photoconductor was produced in the same manner as in Example 1, except that the charge transfer agent used in Example 1 was replaced with the charge transfer agent expressed by Structural Formula (I-2-b).

### Example 15

An electrophotographic photoconductor was produced in the same manner as in Example 1, except that the charge transfer agent used in Example 1 was replaced with the charge transfer agent expressed by Structural Formula (I-2-c).

### Example 16

An electrophotographic photoconductor was produced in the same manner as in Example 1, except that the charge transfer agent used in Example 1 was replaced with the charge transfer agent expressed by Structural Formula (I-2-d).

### Example 17

An electrophotographic photoconductor was produced in the same manner as in Example 1, except that the charge transfer agent used in Example 1 was replaced with the charge transfer agent expressed by Structural Formula (I-2-e).

### Example 18

An electrophotographic photoconductor was produced in the same manner as in Example 6, except that the charge transfer agent used in Example 6 was replaced with the charge transfer agent expressed by Structural Formula (I-2-a).

### Example 19

An electrophotographic photoconductor as produced in the same manner as in Example 7, except that the charge transfer agent used in Example 7 was replaced with the charge transfer agent expressed by Structural Formula (I-2-a).

### Example 20

An electrophotographic photoconductor was produced in the same manner as in Example 8, except that the charge transfer agent used in Example 8 was replaced with the charge transfer agent expressed by Structural Formula (I-2-a).

### Example 21

An electrophotographic photoconductor was produced in the same manner as in Example 9, except that the charge transfer agent used in Example 9 was replaced with the charge transfer agent expressed by Structural Formula (I-2-a).

### Example 22

An electrophotographic photoconductor was produced in the same manner as in Example 10, except that the charge transfer agent used in Example 10 was replaced with the charge transfer agent expressed by Structural Formula (I-2-a).

### Example 23

An electrophotographic photoconductor was produced in the same manner as in Example 11, except that the charge transfer agent used in Example 11 was replaced with the charge transfer agent expressed by Structural Formula (I-2-a).

### Example 24

An electrophotographic photoconductor was produced in the same manner as in Example 12, except that the charge transfer agent used in Example 12 was replaced with the charge transfer agent expressed by Structural Formula (I-2-a).

### Comparative Example 8

An electrophotographic photoconductor was produced in the same manner as in Example 13, except that the charge transfer agent expressed by Structural Formula (I-2-a) used in Example 13 was replaced with the charge transfer agent expressed by Structural Formula (H).

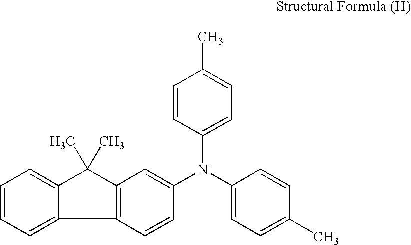

### Comparative Example 9

An electrophotographic photoconductor was produced in the same manner as in Example 13, except that the antioxidant expressed by Structural Formula (II-a) was not added in the charge transfer layer, which contains the charge transfer agent expressed by Structural Formula (I-2-a) in Example 13.

### Comparative Example 10

An electrophotographic photoconductor was produced in the same manner as in Example 13, except that the antioxidant expressed by Structural Formula (II-a) used in Example 13 was replaced with the antioxidant expressed by Structural Formula (B).

### Comparative Example 11

An electrophotographic photoconductor was produced in the same manner as in Example 13, except that the antioxidant expressed by Structural Formula (II-a) was replaced with the antioxidant expressed by Structural Formula (E), that the UV ray absorber expressed by Structural Formula (A) was removed, and that the binder resin, the charge transfer agent expressed by Structural Formula (I-2-a), and the antioxidant expressed by Structural Formula (E) were in a mass ratio of 1.0:1.0:0.1.

### Comparative Example 12

An electrophotographic photoconductor was produced in the same manner as in Example 13, except that the antioxidant expressed by Structural Formula (II-a) was replaced with the antioxidant expressed by Structural Formula (F), that the UV ray absorber expressed by Structural Formula (A) was removed, and that the binder resin, the charge transfer agent expressed by Structural Formula (I-2-a), and the antioxidant expressed by Structural Formula (F) were in a mass ratio of 1.0:1.0:0.1.

### Comparative Example 13

An electrophotographic photoconductor was produced in the same manner as in Example 13, except that in the coating liquid for the charge transfer layer of Example 13 the antioxidant expressed by Structural Formula (II-a) was replaced with the antioxidant expressed by Structural Formula (G), that the UV ray absorber expressed by Structural Formula (A) was removed, and that the binder resin, the charge transfer agent expressed by Structural Formula (I-2-a), and the antioxidant expressed by Structural Formula (G) were in a mass ratio of 1.0:1.0:0.1.

TABLE 3

| | surface potential V0(−V) | | | sensitivity potential VH(−V) | | | residual potential VL(−V) | | |
|---|---|---|---|---|---|---|---|---|---|
| | | ozone | NOx | | ozone | NOx | | ozone | NOx |
| | initial | environment | environment | initial | environment | environment | initial | environment | environment |
| Example 13 | 700 | 685 | 680 | 350 | 345 | 343 | 50 | 50 | 50 |
| Example 14 | 700 | 685 | 683 | 350 | 344 | 342 | 52 | 52 | 52 |
| Example 15 | 700 | 685 | 682 | 355 | 345 | 342 | 50 | 52 | 52 |
| Example 16 | 700 | 683 | 683 | 350 | 345 | 345 | 50 | 53 | 53 |
| Example 17 | 700 | 685 | 686 | 360 | 353 | 354 | 50 | 52 | 52 |
| Example 18 | 700 | 675 | 670 | 348 | 342 | 340 | 50 | 53 | 52 |
| Example 19 | 710 | 695 | 695 | 360 | 355 | 355 | 60 | 60 | 62 |
| Example 20 | 700 | 690 | 692 | 350 | 345 | 342 | 58 | 60 | 60 |
| Example 21 | 710 | 690 | 685 | 360 | 350 | 352 | 60 | 62 | 63 |
| Example 22 | 700 | 690 | 688 | 355 | 345 | 347 | 58 | 59 | 60 |
| Example 23 | 700 | 688 | 687 | 350 | 342 | 344 | 60 | 62 | 61 |
| Example 24 | 705 | 700 | 700 | 352 | 345 | 347 | 60 | 62 | 61 |
| Comparative Example 1 | 710 | 695 | 690 | 400 | 405 | 400 | 160 | 170 | 170 |
| Comparative Example 8 | 710 | 700 | 702 | 380 | 370 | 367 | 110 | 112 | 111 |
| Comparative Example 9 | 700 | 550 | 520 | 350 | 200 | 180 | 50 | 48 | 47 |
| Comparative Example 10 | 705 | 640 | 635 | 360 | 305 | 303 | 60 | 63 | 62 |
| Comparative Example 11 | 710 | 650 | 640 | 365 | 300 | 305 | 72 | 75 | 75 |
| Comparative Example 12 | 710 | 660 | 660 | 370 | 310 | 315 | 73 | 75 | 75 |
| Comparative Example 13 | 705 | 660 | 665 | 355 | 305 | 306 | 55 | 56 | 56 |

TABLE 4

| | ΔID in the case of | ΔID after ozone | ΔID after NOx |
|---|---|---|---|
| | no environmental | environmental | environmental |
| | test performed | test performed | test performed |
| Example 13 | 0 | 0.01 | 0.01 |
| Example 14 | 0 | 0.01 | 0.01 |
| Example 15 | 0 | 0.01 | 0.01 |
| Example 16 | 0 | 0.01 | 0.01 |
| Example 17 | 0 | 0.01 | 0.01 |
| Example 18 | 0 | 0.02 | 0.02 |
| Example 19 | 0 | 0.01 | 0.01 |
| Example 20 | 0 | 0.01 | 0.01 |
| Example 21 | 0 | 0.01 | 0.01 |
| Example 22 | 0 | 0.01 | 0.01 |
| Example 23 | 0 | 0.01 | 0.01 |
| Example 24 | 0 | 0.01 | 0.01 |
| Comparative | 0 | Insufficient | Insufficient |
| Example 1 | | image density | image density |
| | | ΔID could not | ΔID could not |
| | | be evaluated | be evaluated |
| Comparative | 0 | lack of | lack of |
| Example 8 | | concentration | concentration |
| | | ΔID could not | ΔID could not |
| | | be evaluated | be evaluated |
| Comparative | 0 | 0.10 | 0.12 |
| Example 9 | | | |
| Comparative | 0 | 0.05 | 0.06 |
| Example 10 | | | |
| Comparative | 0 | 0.06 | 0.07 |
| Example 11 | | | |
| Comparative | 0 | 0.04 | 0.05 |
| Example 12 | | | |
| Comparative | 0 | 0.04 | 0.04 |
| Example 13 | | | |

In each of Examples 13 to 24, the charge transfer agent expressed by General Formula (I) and the antioxidant expressed by General Formula (II) were added to the photosensitive layer, so that the electrophotographic photoconductor had high sensitivity, high responsiveness, and excellent resistance to ozone and NOx. The electrophotographic photoconductor had good results with respect to the variations in charge potential, sensitivity potential, residual potential, and image density.

The electrophotographic photoconductor of Example 18, in which the small amount of the antioxidant expressed by Structural Formula (II-a) was added, was slightly inferior in the surface potential and sensitivity potential to that of Example 13, but the difference in the image density of the resulted images on paper was practical level.

The electrophotographic photoconductor of Example 19, in which the large amount of the antioxidant expressed by Structural Formula (II-a) was added, had somewhat high VL, but the image density was the same level as that of Example 13.

The electrophotographic photoconductor of Comparative Example 8 was produced by using the charge transfer agent expressed by Structural Formula (H), and had high VH and V0 values, and was hard to respond to a demand for the photoconductor having high sensitivity and high responsiveness.

The electrophotographic photoconductor of Comparative Example 9 was produced without adding the antioxidant expressed by Structural Formula (II-a). The values of V0 and VH after ozone exposure and NOx exposure were significantly decreased, and the value of image density change ΔID was significantly increased. The electrophotographic photoconductors of Comparative Examples 10 to 13 were respectively produced by adding different antioxidants from the antioxidant expressed by General Formula (II) to the sensitive layers. The values of V0 and VH after ozone exposure and NOx exposure were less decreased, and the value of VL was increased in some of the electrophotographic photoconductors. The image density change of each of Comparative Examples 10 to 13 was smaller than that of Comparative Example 3, but was not at the practical level, and inferior to those of Examples 13 to 24.

### Example 25

An electrophotographic photoconductor was produced in the same manner as in Example 1, except that the charge transfer agent used in Example 1 was replaced with the charge transfer agent expressed by Structural Formula (I-3-a).

### Example 26

An electrophotographic photoconductor was produced in the same manner as in Example 1, except that the charge transfer agent used in Example 1 was replaced with the charge transfer agent expressed by Structural Formula (I-3-b).

### Example 27

An electrophotographic photoconductor was produced in the same manner as in Example 1, except that the charge transfer agent used in Example 1 was replaced with the charge transfer agent expressed by Structural Formula (I-3-c).

### Example 28

An electrophotographic photoconductor was produced in the same manner as in Example 1, except that the charge transfer agent used in Example 1 was replaced with the charge transfer agent expressed by Structural Formula (I-3-d).

### Example 29

An electrophotographic photoconductor was produced in the same manner as in Example 6, except that the charge transfer agent used in Example 6 was replaced with the charge transfer agent expressed by Structural Formula (I-3-a).

### Example 30

An electrophotographic photoconductor was produced in the same manner as in Example 7, except that the charge transfer agent used in Example 7 was replaced with the charge transfer agent expressed by Structural Formula (I-3-a).

### Example 31

An electrophotographic photoconductor was produced in the same manner as in Example 8, except that the charge transfer agent used in Example 8 was replaced with the charge transfer agent expressed by Structural Formula (I-3-a).

### Example 32

An electrophotographic photoconductor was produced in the same manner as in Example 9, except that the charge transfer agent used in Example 9 was replaced with the charge transfer agent expressed by Structural Formula (I-3-a).

### Example 33

An electrophotographic photoconductor was produced in the same manner as in Example 10, except that the charge transfer agent used in Example 10 was replaced with the charge transfer agent expressed by Structural Formula (I-3-a).

### Example 34

An electrophotographic photoconductor was produced in the same manner as in Example 11, except that the charge transfer agent used in Example 11 was replaced with the charge transfer agent expressed by Structural Formula (I-3-a).

### Example 35

An electrophotographic photoconductor was produced in the same manner as in Example 12, except that the charge transfer agent used in Example 12 was replaced with the charge transfer agent expressed by Structural Formula (I-3-a).

### Comparative Example 14

An electrophotographic photoconductor was produced in the same manner as in Example 25, except that the antioxidant expressed by Structural Formula (II-a) was not contained in the charge transfer layer of Example 25.

### Comparative Example 15

An electrophotographic photoconductor was produced in the same manner as in Example 25, except that the antioxidant expressed by Structural Formula (II-a) used in Example 25 was replaced with the antioxidant expressed by Structural Formula (B).

### Comparative Example 16

An electrophotographic photoconductor was produced in the same manner as in Example 25, except that the antioxidant expressed by Structural Formula (II-a) used in Example 25 was replaced with the amine antioxidant expressed by Structural Formula (E).

### Comparative Example 17

An electrophotographic photoconductor was produced in the same manner as in Example 25, except that the antioxidant expressed by Structural Formula (II-a) used in Example 25 was replaced with the amine antioxidant expressed by Structural Formula (F).

### Comparative Example 18

An electrophotographic photoconductor was produced in the same manner as in Example 25, except that the antioxidant expressed by Structural Formula (II-a) used in Example 25 was replaced with the amine antioxidant expressed by Structural Formula (G).

TABLE 5

| | surface potential V0(−V) | | | sensitivity potential VH(−V) | | | residual potential VL(−V) | | |
|---|---|---|---|---|---|---|---|---|---|
| | | ozone | NOx | | ozone | NOx | | ozone | NOx |
| | initial | environment | environment | initial | environment | environment | initial | environment | environment |
| Example 25 | 700 | 685 | 685 | 340 | 335 | 332 | 40 | 40 | 40 |
| Example 26 | 700 | 685 | 685 | 340 | 333 | 332 | 40 | 40 | 40 |
| Example 27 | 700 | 685 | 683 | 347 | 338 | 337 | 40 | 41 | 42 |
| Example 28 | 700 | 682 | 682 | 340 | 335 | 332 | 40 | 40 | 40 |
| Example 29 | 700 | 675 | 675 | 340 | 332 | 330 | 38 | 38 | 38 |
| Example 30 | 705 | 690 | 692 | 350 | 345 | 346 | 45 | 45 | 45 |
| Example 31 | 700 | 685 | 685 | 345 | 340 | 342 | 48 | 47 | 46 |
| Example 32 | 700 | 685 | 682 | 340 | 332 | 332 | 42 | 43 | 45 |
| Example 33 | 700 | 685 | 681 | 340 | 333 | 332 | 45 | 45 | 45 |
| Example 34 | 700 | 685 | 682 | 345 | 337 | 338 | 43 | 45 | 45 |
| Example 35 | 700 | 695 | 693 | 345 | 340 | 341 | 45 | 45 | 45 |
| Comparative Example 1 | 710 | 695 | 690 | 400 | 405 | 400 | 160 | 170 | 170 |
| Comparative Example 2 | 710 | 700 | 702 | 380 | 370 | 367 | 110 | 112 | 111 |
| Comparative Example 14 | 700 | 500 | 510 | 350 | 180 | 165 | 40 | 38 | 37 |
| Comparative Example 15 | 705 | 640 | 635 | 360 | 305 | 303 | 60 | 63 | 62 |
| Comparative Example 16 | 710 | 650 | 640 | 365 | 300 | 305 | 72 | 75 | 75 |
| Comparative Example 17 | 710 | 660 | 660 | 368 | 310 | 315 | 73 | 75 | 75 |
| Comparative Example 18 | 705 | 660 | 665 | 355 | 305 | 306 | 55 | 56 | 56 |

TABLE 6

| | ΔID in the case of | ΔID after ozone | ΔID after NOx |
|---|---|---|---|
| | no environmental | environmental | environmental |
| | test performed | test performed | test performed |
| Example 25 | 0 | 0.01 | 0.01 |
| Example 26 | 0 | 0.01 | 0.01 |
| Example 27 | 0 | 0.01 | 0.01 |
| Example 28 | 0 | 0.01 | 0.01 |
| Example 29 | 0 | 0.02 | 0.02 |
| Example 30 | 0 | 0.01 | 0.01 |
| Example 31 | 0 | 0.01 | 0.01 |
| Example 32 | 0 | 0.01 | 0.01 |
| Example 33 | 0 | 0.01 | 0.01 |
| Example 34 | 0 | 0.01 | 0.01 |
| Example 35 | 0 | 0.01 | 0.01 |
| Comparative | 0 | Insufficient | Insufficient |
| Example 1 | | image density | image density |
| | | ΔID could not | ΔID could not |
| | | be evaluated | be evaluated |
| Comparative | 0 | Insufficient | Insufficient |
| Example 2 | | image density | image density |
| | | ΔID could not | ΔID could not |
| | | be evaluated | be evaluated |
| Comparative | 0 | 0.12 | 0.13 |
| Example 14 | | | |
| Comparative | 0 | 0.07 | 0.07 |
| Example 15 | | | |
| Comparative | 0 | 0.06 | 0.07 |
| Example 16 | | | |
| Comparative | 0 | 0.04 | 0.05 |
| Example 17 | | | |
| Comparative | 0 | 0.04 | 0.04 |
| Example 18 | | | |

In each of Examples 25 to 35, the charge transfer agent expressed by General Formula (I) and the antioxidant expressed by General Formula (II) were added to the photosensitive layer, so that the electrophotographic photoconductor had high sensitivity, high responsiveness, and excellent resistance to ozone and NOx. The electrophotographic photoconductor had good results with respect to the variations in charge potential, sensitivity potential, residual potential, and image density.

The electrophotographic photoconductor of Example 29, in which the small amount of the antioxidant expressed by Structural Formula (II-a) was added, was slightly inferior in the surface potential and sensitivity potential to that of Example 25, but the difference in the image density of the resulted images on paper was practical level. The electrophotographic photoconductor of Example 30, in which the large amount of the antioxidant expressed by Structural Formula (II-a) was added, had somewhat high VL, but the image density was the same level as that of Example 25.

The electrophotographic photoconductor of Comparative Example 16 was produced without adding the antioxidant expressed by Structural Formula (II-a). The values of V0 and VH after ozone exposure and NOx exposure were significantly decreased, and the value of image density change ΔID was significantly increased. The electrophotographic photoconductors of Comparative Examples 17 to 20 were respectively produced by adding different antioxidants from the antioxidant expressed by General Formula (II) to the sensitive layer. The values of V0 and VH after ozone exposure and NOx exposure were less decreased, and the value of VL was increased in some of the electrophotographic photoconductors. The image density change of each of Comparative Examples 17 to 20 was smaller than that of Comparative Example 16, but was not at the practical level, and inferior to those of Examples 25 to 35.

As can be seen from the description above, according to the present invention, the electrophotographic photoconductor, which includes the photosensitive layer containing the charge generation agent, the charge transfer agent expressed by General Formula (I) and the antioxidant expressed by General Formula (II), has less variation in the charge potential, sensitivity potential, and residual potential, has high responsiveness and has improved resistance to ozone and NOx.

What is claimed is:

1. An electrophotographic photoconductor comprising;
a conductive substrate; and
a photosensitive layer formed on the conductive substrate,
wherein the photosensitive layer contains a charge generation agent, a charge transfer agent expressed by General Formula (I), and an antioxidant expressed by General Formula (II): 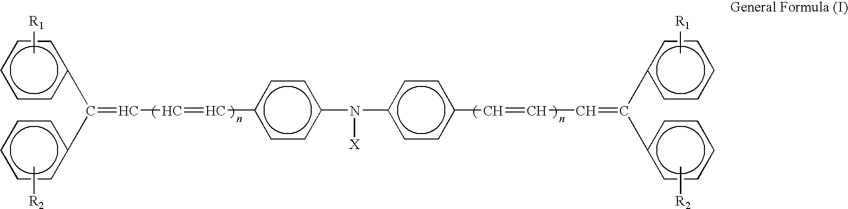
in General Formula (I), X represents any one of General Formulas (III) and (IV); R₁ and R₂ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1; 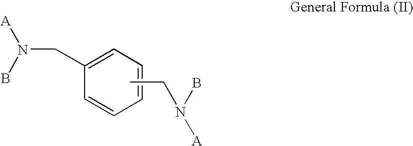
in General Formula (II), A and B each represent any one of substituents expressed by (i) and (ii), and may be identical to each other or different;
—CH₂Y₁, and (i)
—CH₂CH₂Y₂ (ii)
in (i) and (ii), Y₁ and Y₂ each represent an aromatic residue which may have a substituent; 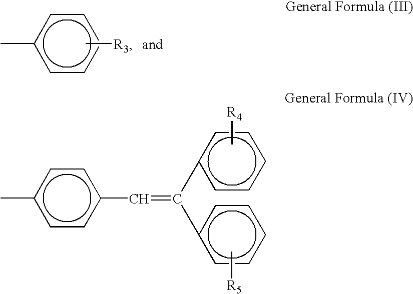
in General Formulas (III) and (IV), R₃ to R₅ each represent an alkyl group having 1 to 6 carbon atoms or an alkoxyl group having 1 to 6 carbon atoms, which may have any one of a hydrogen atom, a halogen atom, and a substituent; and n represents an integer of 0 or 1.

2. The electrophotographic photoconductor according to claim 1, wherein the charge transfer agent expressed by General Formula (I) is a charge transfer agent expressed by General Formula (I-1); 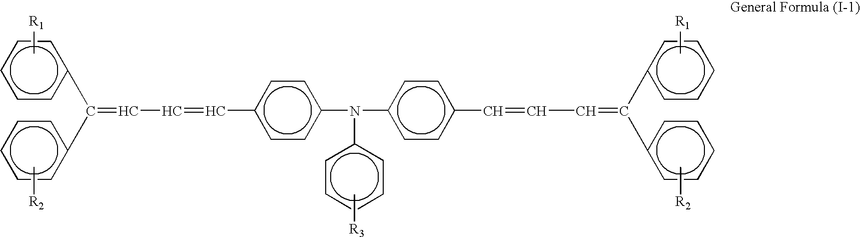
in General Formula (I-1), R₁ to R₃ each represent an alkyl group having 1 to 6 carbon atoms or an alkoxyl group having 1 to 6 carbon atoms, which may have any one of a hydrogen atom, a halogen atom, and a substituent.

3. The electrophotographic photoconductor according to claim 1, wherein the charge transfer agent expressed by General Formula (I) is a charge transfer agent expressed by General Formula (I-2): 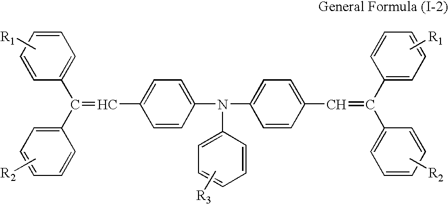
in General Formula (I-2), R₁ to R₃ each represent an alkyl group having 1 to 6 carbon atoms or an alkoxyl group having 1 to 6 carbon atoms, which may have any one of a hydrogen atom, a halogen atom, and a substituent.

4. The electrophotographic photoconductor according to claim 1, wherein the charge transfer agent expressed by General Formula (I) is a charge transfer agent expressed by General Formula (I-3): 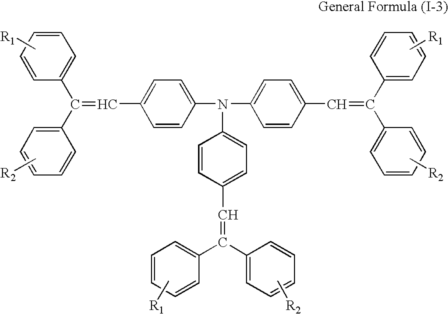
in General Formula (I-3), R₁ and R₂ each represent an alkyl group having 1 to 6 carbon atoms or an alkoxyl group having 1 to 6 carbon atoms, which may have any one of a hydrogen atom, a halogen atom, and a substituent.

5. The electrophotographic photoconductor according to claim 2, wherein the charge transfer agent expressed by General Formula (I-1) is at least one selected from the group consisting of charge transfer agents expressed by Structural Formulas (I-1-a) to (I-1-e):

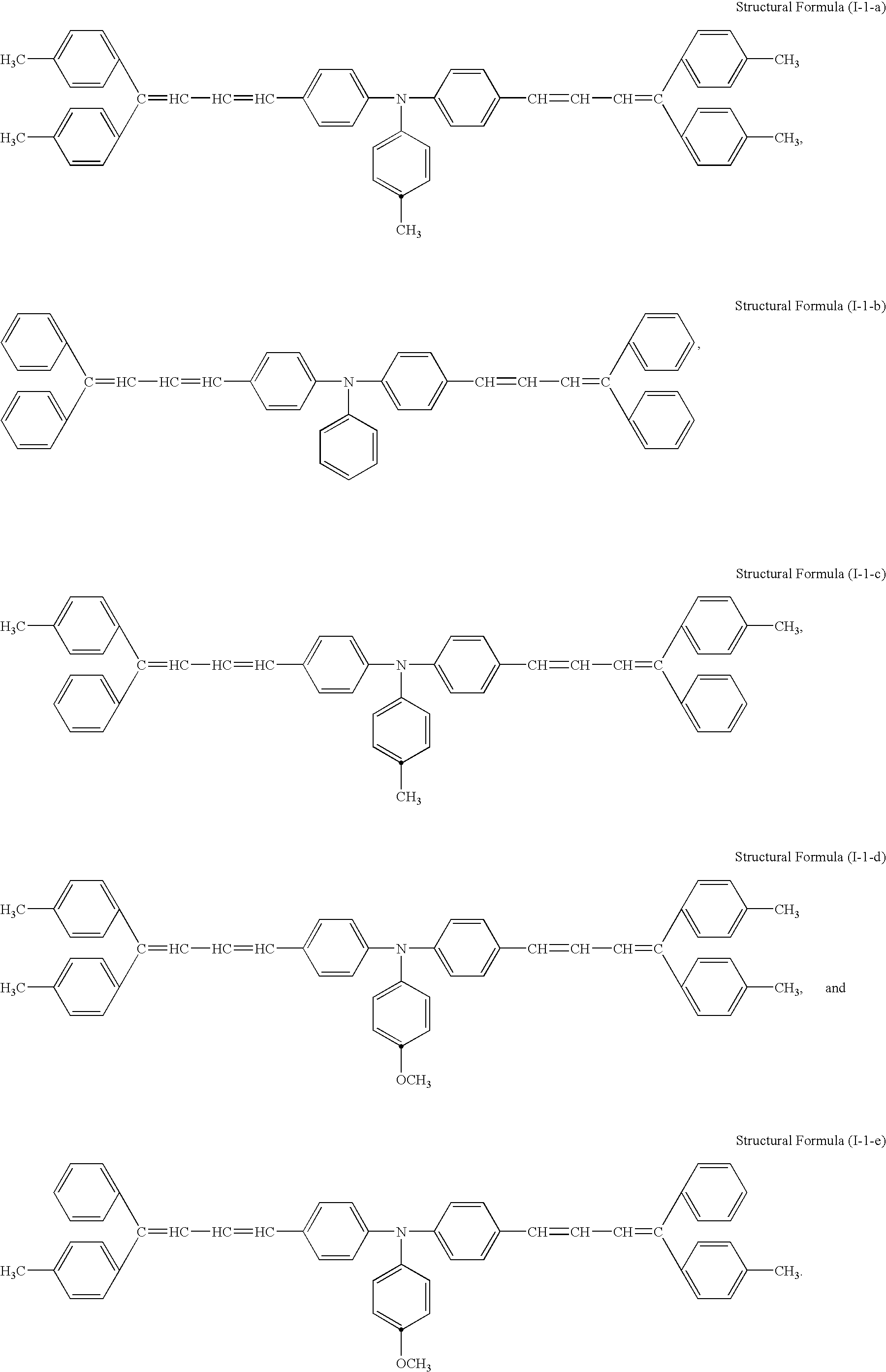

6. The electrophotographic photoconductor according to claim 3, wherein the charge transfer agent expressed by General Formula (I-2) is at least one selected from the group consisting of charge transfer agents expressed by Structural Formulas (I-2-a) to (I-2-e):

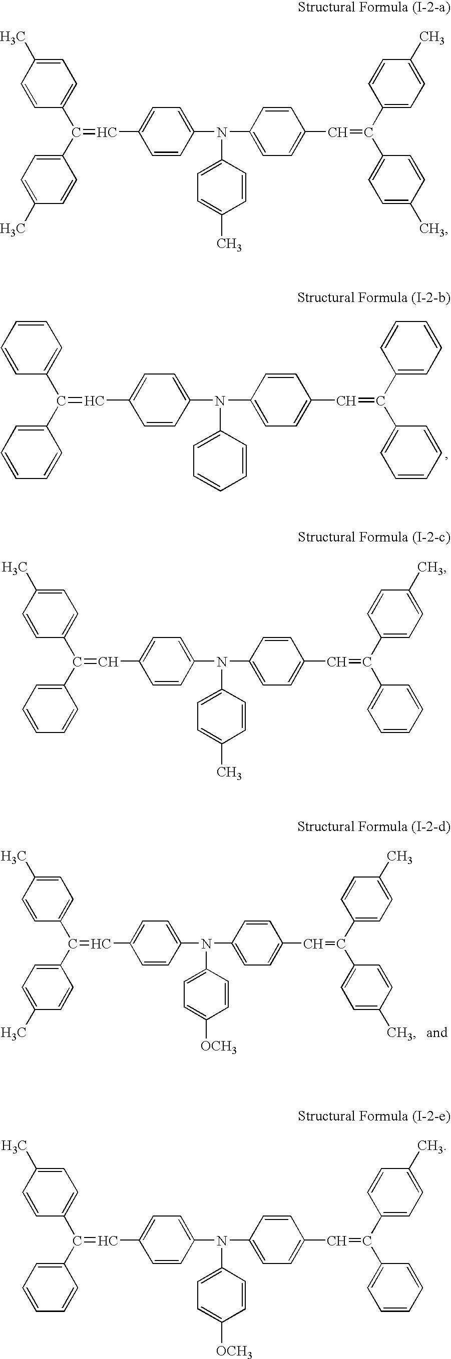

7. The electrophotographic photoconductor according to claim 4, wherein the charge transfer agent expressed by General Formula (I-3) is at least one selected from the group consisting of charge transfer agents expressed by Structural Formulas (I-3-a) to (I-3-d):

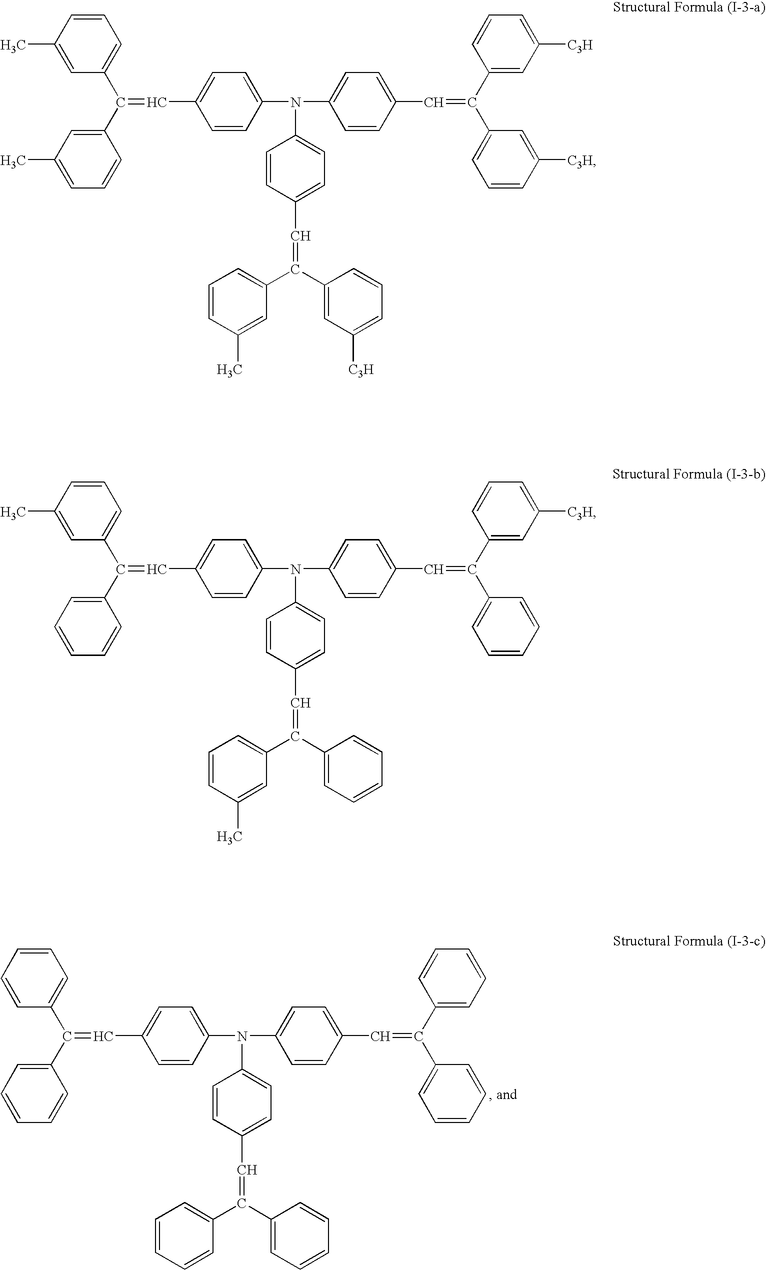

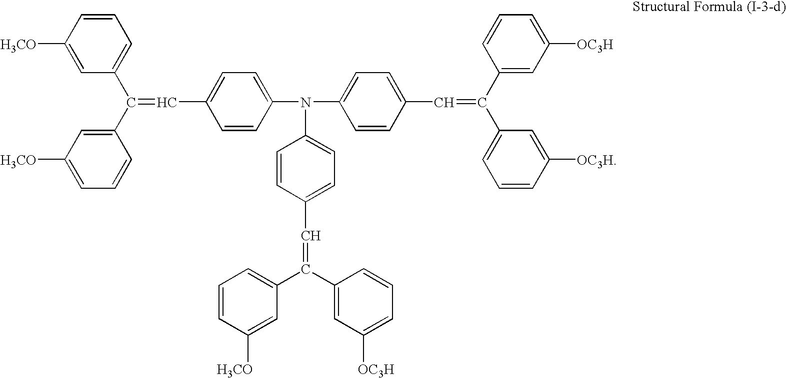

8. The electrophotographic photoconductor according to claim 1, wherein the antioxidant expressed by General Formula (II) is at least one selected from the group consisting of antioxidants expressed by Structural Formulas (II-a) to (II-e):

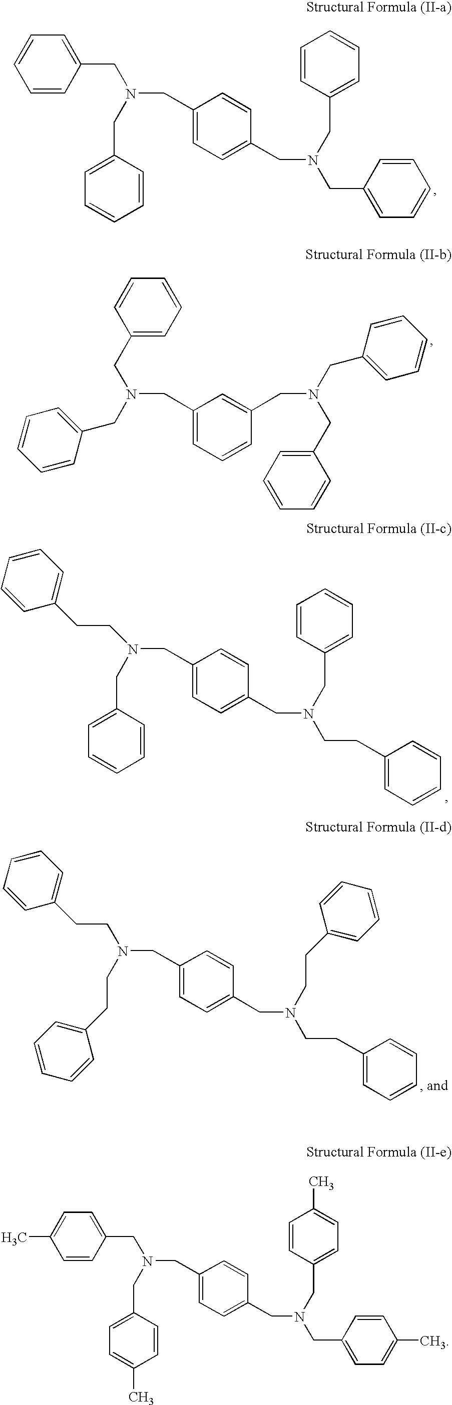

9. The electrophotographic photoconductor according to claim 1, wherein the photosensitive layer further contains a benzotriazole UV ray absorber.

10. The electrophotographic photoconductor according to claim 1, wherein the photosensitive layer further contains a phenol antioxidant.
